(19) United States
(12) Patent Application Publication
(10) Pub. No.: US 2026/0120925 A1
(43) Pub. Date: Apr. 30, 2026

(54) R-T-B BASED PERMANENT MAGNET AND METHOD OF MANUFACTURING THE SAME

(71) Applicant: TDK CORPORATION, Tokyo (JP)

(72) Inventors: Koji MIURA, Tokyo (JP); Hiroki KAWAMURA, Tokyo (JP)

(73) Assignee: TDK CORPORATION, Tokyo (JP)

(21) Appl. No.: 19/365,813

(22) Filed: Oct. 22, 2025

(30) Foreign Application Priority Data
Oct. 25, 2024 (JP) 2024-188423
Aug. 25, 2025 (JP) 2025-140021

(51) Int. Cl. H01F 1/057; B22F 3/16; B22F 3/24; B22F 9/02; B22F 9/04; C22C 33/02; C22C 38/00; C22C 38/06; C22C 38/10; C22C 38/14; C22C 38/16; H01F 41/02

(52) U.S. Cl. CPC H01F 1/0577; B22F 3/16; B22F 3/24; B22F 9/023; B22F 9/04; C22C 33/0207; C22C 33/0278; C22C 38/001; C22C 38/002; C22C 38/005; C22C 38/06; C22C 38/10; C22C 38/14; C22C 38/16; H01F 41/0253; B22F 2003/247; B22F 2003/248; B22F 2201/11; B22F 2202/05; B22F 2301/355; B22F 2998/10; B22F 2999/00; C22C 2202/02

(57) ABSTRACT

An R-T-B based permanent magnet contains 28.0 mass % or more and 31.5 mass % or less light rare earth element in total, more than 0 mass % and 1.0 mass % or less heavy rare earth element in total, 0.97 mass % or more and 1.05 mass % or less B, 0.05 mass % or more and 0.52 mass % or less Al, 0.50 mass % or more and 0.75 mass % or less Zr, 0 mass % or more and 0.20 mass % or less Ga, and 0 mass ppm or more and 1000 mass ppm or less O. The R-T-B based permanent magnet has a coercivity of 715 kA/m or more at 160° C.

### TECHNICAL FIELD

The present disclosure relates to an R-T-B based permanent magnet and a method of manufacturing the same.

### BACKGROUND

Patent Document 1 discloses an invention related to an R-T-B based permanent magnet with both high residual magnetic flux density Br at room temperature and high coercivity HcJ at high temperatures due to grain boundary diffusion of a heavy rare earth element.

Patent Document 2 discloses an invention related to a Nd—Fe—B based rare earth permanent magnet with controlled abnormal grain growth, a broader optimum sintering temperature range, and better magnetic properties at a high carbon concentration and a low oxygen concentration by having a specific alloy composition structure.
Patent Document 1: JP Patent Application Laid Open No. 2022-008212
Patent Document 2: JP Patent Application Laid Open No. 2006-210893

### SUMMARY

An R-T-B based permanent magnet according to the present disclosure contains
28.0 mass % or more and 31.5 mass % or less light rare earth element in total,
more than 0 mass % and 1.0 mass % or less heavy rare earth element in total,
0.97 mass % or more and 1.05 mass % or less B,
0.05 mass % or more and 0.52 mass % or less Al,
0.50 mass % or more and 0.75 mass % or less Zr,
0 mass % or more and 0.20 mass % or less Ga, and
0 mass ppm or more and 1000 mass ppm or less O,
wherein the R-T-B based permanent magnet has a coercivity of 715 kA/m or more at 160° C.

A method of manufacturing an R-T-B based permanent magnet according to the present disclosure includes
preparing a main alloy and a sub alloy; and
mixing the main alloy and the sub alloy,
wherein
the main alloy contains 1.03 mass % or more and 1.11 mass % or less B, and
the sub alloy contains 0.96 mass % or more and 15.0 mass % or less Zr.

### BRIEF DESCRIPTION OF THE DRAWING(S)

FIG. 1 is a schematic view of an R-T-B based permanent magnet.

FIG. 2 is a SEM image of a cross-section of the R-T-B based permanent magnet.

### DETAILED DESCRIPTION

It is an object of the present disclosure to provide an R-T-B based permanent magnet having high residual magnetic flux density Br at room temperature, high coercivity HcJ at room temperature, a high squareness ratio Hk/HcJ at room temperature, and high coercivity HcJ at high temperatures.

The R-T-B based permanent magnet may contain 0.53 mass % or more and 0.75 mass % or less Zr.

The R-T-B based permanent magnet may contain more than 0 mass % and 0.20 mass % or less heavy rare earth element in total.

The R-T-B based permanent magnet may contain 0.50 mass % or more and 0.80 mass % or less Co.

The R-T-B based permanent magnet may have a concentration gradient of the heavy rare earth element decreasing inward from a surface of the R-T-B based permanent magnet.

The R-T-B based permanent magnet may include main phase grains, and a grain boundary between two or more of the main phase grains adjacent to each other; the grain boundary may include a Zr—C phase; and the Zr—C phase may occupy an area ratio of 0.50% or more and 2.60% or less of a cross-section of the R-T-B based permanent magnet.

A method of manufacturing an R-T-B based permanent magnet according to the present disclosure includes
preparing a main alloy and a sub alloy; and
mixing the main alloy and the sub alloy,
wherein
the main alloy contains 1.03 mass % or more and 1.11 mass % or less B, and
the sub alloy contains 0.96 mass % or more and 15.0 mass % or less Zr.

Hereinafter, the present disclosure is described based on an embodiment.

An R-T-B based permanent magnet includes main phase grains including crystal grains having an R₂T₁₄B type crystal structure. The R-T-B based permanent magnet further includes grain boundaries, each of which is in between two or more of the main phase grains adjacent to each other.

In the R-T-B based permanent magnet and the R₂T₁₄B type crystal structure, “R” represents at least one rare earth element, “T” represents at least one transition metal element, and “B” represents boron.

The at least one rare earth element contained as “R” in the R-T-B based permanent magnet and the R₂T₁₄B type crystal structure may include Sc, Y, or lanthanoid. The at least one transition metal element contained as “T” does not include rare earth elements. The at least one transition metal element contained as “T” may include at least one iron group element. The at least one iron group element contained as “T” may include only Fe. Fe contained as “T” may be partly substituted with Co. Boron contained as “B” may be partly substituted with carbon.

In the present embodiment, rare earth elements are classified into heavy rare earth elements and light rare earth elements. Heavy rare earth elements include Gd, Tb, Dy, Ho, Er, Tm, Yb, and Lu. Light rare earth elements include rare earth elements other than the heavy rare earth elements. Iron group elements include Fe, Co, and Ni.

The R-T-B based permanent magnet according to the present embodiment contains at least aluminum (Al) and zirconium (Zr) other than the at least one rare earth element, the at least one iron group element, and boron. The R-T-B based permanent magnet may further contain gallium (Ga), copper (Cu), carbon (C), nitrogen (N), and oxygen (O). The R-T-B based permanent magnet has the following composition and the following properties.

The R-T-B based permanent magnet according to the present embodiment may have any total rare earth element content (which may hereinafter be referred to as TRE). The R-T-B based permanent magnet may substantially contain only at least one selected from the group consisting of Nd, Pr, Dy, and Tb as the at least one rare earth element or may substantially contain only at least one selected from the group consisting of Nd, Pr, and Tb as the at least one rare earth element. The phrase “substantially contain only at least one selected from the group consisting of Nd, Pr, Dy, and Tb as the at least one rare earth element” means that the content of rare earth elements other than Nd, Pr, Dy, and Tb of the R-T-B based permanent magnet is 0.01 mass % or less in total. The phrase “substantially contain only at least one selected from the group consisting of Nd, Pr, and Tb as the at least one rare earth element” means that the content of rare earth elements other than Nd, Pr, and Tb of the R-T-B based permanent magnet is 0.01 mass % or less in total.

Out of 100 mass % of the R-T-B based permanent magnet, the R-T-B based permanent magnet has a total light rare earth element content (which may hereinafter be referred to as TRL) of 28.0 mass % or more and 31.5 mass % or less. Too high a TRL readily decreases Br at room temperature. Too low a TRL makes it difficult to manufacture the R-T-B based permanent magnet by sintering.

The R-T-B based permanent magnet may contain any light rare earth element. The R-T-B based permanent magnet may contain, for example, Nd and/or Pr. Nd/Pr may be 1.9 or more in atomic ratio. Nd/Pr may be 1000 or less in atomic ratio.

Out of 100 mass % of the R-T-B based permanent magnet, the R-T-B based permanent magnet has a total heavy rare earth element content (which may hereinafter be referred to as TRH) of more than 0 mass % and 1.0 mass % or less. TRH may be more than 0 mass % and 0.20 mass % or less. The lower the TRH, the lower the HcJ at room temperature and HcJ at high temperatures tend to be. The higher the TRH, the lower the Br at room temperature tends to be. The higher the TRH, the higher the raw material costs tend to be.

The R-T-B based permanent magnet may have any Co content. Out of 100 mass % of the R-T-B based permanent magnet, the Co content may be 0 mass % or more and 2.00 mass % or less, 0.25 mass % or more and 1.25 mass % or less, or 0.50 mass % or more and 0.80 mass % or less.

A low Co content tends to decrease corrosion resistance. The higher the Co content, the lower the HcJ at room temperature and HcJ at high temperatures tend to be.

Co is relatively expensive. Too high a Co content decreases HcJ, causes a corrosion resistance improving effect to level off, and increases costs.

Despite having a relatively low content of expensive Co, the R-T-B based permanent magnet according to the present embodiment has high corrosion resistance. Thus, the R-T-B based permanent magnet according to the present embodiment readily has high corrosion resistance at a low cost.

The R-T-B based permanent magnet may substantially not contain Ni. Specifically, the Ni content may be 0 mass % or more and less than 0.01 mass %.

Out of 100 mass % of the R-T-B based permanent magnet, the R-T-B based permanent magnet has a Zr content of 0.50 mass % or more and 0.75 mass % or less. The Zr content may be 0.51 mass % or more and 0.75 mass % or less, or may be 0.53 mass % or more and 0.75 mass % or less. The lower the Zr content, the lower the HcJ at room temperature and HcJ at high temperatures tend to be. The higher the Zr content, the lower the Br at room temperature and Hk/HcJ at room temperature tend to be.

Out of 100 mass % of the R-T-B based permanent magnet, the R-T-B based permanent magnet has an Al content of 0.05 mass % or more and 0.52 mass % or less. The Al content may be 0.13 mass % or more and 0.45 mass % or less. The lower the Al content, the lower the HcJ at room temperature and HcJ at high temperatures tend to be. The higher the Al content, the lower the Br at room temperature tends to be.

Out of 100 mass % of the R-T-B based permanent magnet, the R-T-B based permanent magnet has a Ga content of 0 mass % or more and 0.20 mass % or less. The Ga content may be 0.03 mass % or more and 0.14 mass % or less. The lower the Ga content, the lower the HcJ at room temperature and HcJ at high temperatures tend to be. The higher the Ga content, the lower the Br at room temperature and Hk/HcJ at room temperature tend to be.

The R-T-B based permanent magnet may have any Cu content. Out of 100 mass % of the R-T-B based permanent magnet, the Cu content may be 0 mass % or more and 0.50 mass % or less, or may be 0 mass % or more and 0.35 mass % or less. The above range of the Cu content readily improves HcJ at high temperatures and Br.

Out of 100 mass % of the R-T-B based permanent magnet, the R-T-B based permanent magnet has a B content of 0.97 mass % or more and 1.05 mass % or less. Too high or too low a B content readily decreases HcJ at room temperature and Hk/HcJ at room temperature.

Out of 100 mass % of the R-T-B based permanent magnet, the R-T-B based permanent magnet may have a C content of 1100 mass ppm or less. The R-T-B based permanent magnet may have a N content of 700 mass ppm or less.

Out of 100 mass % of the R-T-B based permanent magnet, the R-T-B based permanent magnet has an O content of 1000 mass ppm or less. Too high an O content readily decreases HcJ.

“Out of 100 mass % of the R-T-B based permanent magnet” means that the total content of all elements is 100 mass %. The Fe content of the R-T-B based permanent magnet may substantially be the balance of the R-T-B based permanent magnet. Specifically, the content of each element other than the above elements, i.e., the content of each element other than rare earth elements, Fe, Co, Ni, B, Al, Ga, Zr, Cu, C, N, and O, may be 0.20 mass % or less, or their total may be 1.00 mass % or less.

The R-T-B based permanent magnet has a coercivity of 715 kA/m or more at 160° C. (high temperature).

The R-T-B based permanent magnet may have any shape. Examples of such shapes include a rectangular parallelepiped shape.

The R-T-B based permanent magnet may have a concentration gradient of at least one heavy rare earth element RH decreasing from an outer side to an inner side of the R-T-B based permanent magnet 1. RH with the above concentration gradient may include any heavy rare earth element or elements. RH may include, for example, Dy and/or Tb, or Tb.

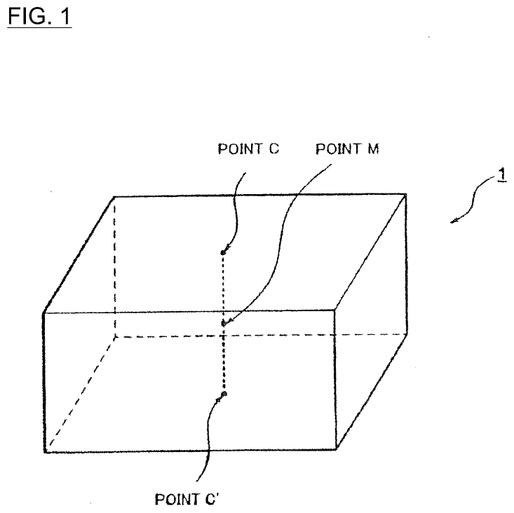

Specifically, as shown in FIG. 1, the R-T-B based permanent magnet 1 having a rectangular parallelepiped shape includes surface portions and a center portion; and the surface portions can have an RH content higher than that of the center portion by 2% or more, 5% or more, or 10% or more. The surface portions mean surfaces of the R-T-B based permanent magnet 1. The surface portions include, for example, POINT C and POINT C′ shown in FIG. 1 (centroids of surfaces facing each other in FIG. 1). The center portion means a center of the R-T-B based permanent magnet 1. The center portion is, for example, at half the thickness of the R-T-B based permanent magnet 1. The center portion is, for example, POINT M shown in FIG. 1 (a midpoint between POINT C and POINT C′). POINT C and POINT C′ in FIG. 1 may be a centroid of a surface having the largest area among surfaces of the R-T-B based permanent magnet 1 and a centroid of a surface facing the former surface, respectively.

Any method of providing the R-T-B based permanent magnet with the above RH concentration gradient may be used. For example, grain boundary diffusion (described later) of RH can be used to provide the R-T-B based permanent magnet with the RH concentration gradient.

The grain boundaries of the R-T-B based permanent magnet according to the present embodiment may include a Zr—C phase. The grain boundaries may further include a Zr—B phase or may include phases rich in R and C.

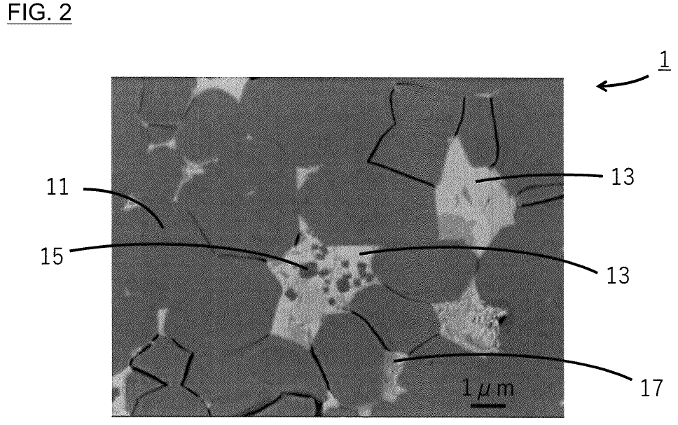

FIG. 2 is an example SEM image (backscattered electron image obtained using a SEM) of a cross-section of the R-T-B based permanent magnet according to the present embodiment. The magnification of FIG. 2 is 10000×. FIG. 2 is a SEM image of a cross-section of Sample No. 5, which is an example described later.

The R-T-B based permanent magnet 1 includes the main phase grains 11 and the grain boundaries 13, each of which is between two or more of the main phase grains 11 adjacent to each other. Among the grain boundaries 13, those provided between three or more of the main phase grains 11 are triple junctions, which include Zr—C phases 15 having a substantially square shape and Zr—B phases 17 having an elongated shape.

The area ratio of the Zr—C phases in a cross-section of the R-T-B based permanent magnet may be 0.5% or more and 2.6% or less or may be 1.2% or more and 1.8% or less.

By containing RH, the main phase grains have high magnetocrystalline anisotropy. Consequently, HcJ of the R-T-B based permanent magnet is improved.

RH readily bonds with C. Thus, in a situation where the grain boundaries of the R-T-B based permanent magnet include phases rich in R and C, RH is readily incorporated into these phases rich in R and C and is less readily incorporated into the main phase grains. In a situation where the grain boundaries of the R-T-B based permanent magnet include the phases rich in R and C, the main phase grains contain less RH. This decreases HcJ of the R-T-B based permanent magnet.

The phases rich in R and C may be of any type. Examples of such phases include an R—C phase, an R—O—C phase, and an R—O—C—N phase. The C content of the phases rich in R and C may be higher than the C content of the main phase grains. The total R content of the phases rich in R and C may be higher than the total R content of the main phase grains.

The grain boundaries of the R-T-B based permanent magnet may include the Zr—C phases. In a situation where the grain boundaries include the Zr—C phases, the existence ratio of the phases rich in R and C in the grain boundaries is relatively decreased, and the main phase grains readily contain more RH. Thus, the R-T-B based permanent magnet readily has high HcJ.

Too high an area ratio of the Zr—C phases in a cross-section of the R-T-B based permanent magnet readily decreases the volume ratio of the main phase grains in the R-T-B based permanent magnet. A decrease in the volume ratio of the main phase grains readily decreases Br of the R-T-B based permanent magnet.

In a situation where the R-T-B based permanent magnet has a low Zr content, the area ratio of the Zr—C phases in a cross-section of the R-T-B based permanent magnet is readily decreased. In a situation where the R-T-B based permanent magnet has a high Zr content, the area ratio of the Zr—C phases in a cross-section of the R-T-B based permanent magnet is readily increased.

In a situation where the R-T-B based permanent magnet contains Zr, the grain boundaries of the R-T-B based permanent magnet may include the Zr—B phase in addition to the Zr—C phase described above.

In a situation where, in particular, the grain boundaries of the R-T-B based permanent magnet with a low B content include the Zr—B phases, the volume ratio of the main phase grains is readily decreased. This is because B required to form the main phase grains tends to be insufficient. Consequently, HcJ of the R-T-B based permanent magnet is readily decreased.

In a situation where, in particular, the grain boundaries of the R-T-B based permanent magnet with a high B content include the Zr—B phases, the area ratio of the Zr—C phases in a cross-section of the R-T-B based permanent magnet is readily decreased. This is because Zr required to form the Zr—C phase tends to be insufficient.

It is assumed that the ease of formation of the Zr—C phases is related to the melting point of the grain boundaries. Thus, controlling the content of elements (e.g., Al, Co, Cu, and Ga) contained mainly in the grain boundaries of the R-T-B based permanent magnet can control formation of the Zr—C phases.

In a situation where the R-T-B based permanent magnet has a high O content, the R—O—C phase content is readily increased. In this situation, the R—O—C phases readily contain more RH. This readily decreases HcJ of the R-T-B based permanent magnet.

The area ratio of the Zr—C phases can be found using, for example, the following method.

Zr and C elemental mapping of a cross-section of the R-T-B based permanent magnet is performed. Methods of elemental mapping or apparatuses for performing elemental mapping are not limited. Any apparatus with which elemental mapping can be appropriately performed is used. Examples include EPMA and EDS. The magnification is any magnification at which the Zr—C phases can be appropriately measured. The magnification may be, for example, 1500× or more and 10000× or less.

A Zr elemental mapping image and a C elemental mapping image are superimposed. Among the grain boundaries, regions containing both at least 30 at % Zr and at least 30 at % C are defined as the Zr—C phases. The ratio of the area of the Zr—C phases to the area of the R-T-B based permanent magnet is defined as the area ratio. Note that the area of pores surrounded by the main phase grains and/or the grain boundaries is included in the area of the R-T-B based permanent magnet.

### <Method of Manufacturing R-T-B Based Permanent Magnet>

An example method of manufacturing the R-T-B based permanent magnet according to the present embodiment is described below. The R-T-B based permanent magnet may be an R-T-B based sintered permanent magnet resulting through a sintering step. The method of manufacturing the R-T-B based permanent magnet according to the present embodiment may include the following steps.
(a) an alloy preparation step of preparing a main alloy and a sub alloy
(b) a pulverization step of pulverizing the main alloy and the sub alloy
(c) a mixing step of mixing the main alloy and the sub alloy
(d) a pressing step of pressing a resultant alloy powder
(e) a sintering step of sintering a green compact to provide the R-T-B based permanent magnet
(f) an aging treatment step of age-treating the R-T-B based permanent magnet
(g) a cooling step of cooling the R-T-B based permanent magnet
(h) a machining step of machining the R-T-B based permanent magnet
(i) a grain boundary diffusion step of diffusing a heavy rare earth element or elements to grain boundaries of the R-T-B based permanent magnet
(j) a surface treatment step of surface-treating the R-T-B based permanent magnet

Some of the above steps may be omitted as appropriate according to, for example, the type of the R-T-B based permanent magnet eventually manufactured.

However, the method of manufacturing the R-T-B based permanent magnet according to the present embodiment always includes at least the alloy preparation step (step (a)) and the mixing step (step (c)). A main alloy has a B content of 1.03 mass % or more and 1.11 mass % or less. A sub alloy has a Zr content of 0.96 mass % or more and 15.0 mass % or less.

### (Alloy Preparation Step)

First, the main alloy and the sub alloy are prepared (alloy preparation step). The R-T-B based permanent magnet having the above structure is manufactured using a two-alloy method, in which the main alloy and the sub alloy are used. There is no difference between a method of preparing the main alloy and a method of preparing the sub alloy. A strip casting method is described below as an example method of preparing the main alloy; however, methods of preparing the alloy are not limited to the strip casting method. With regard to the method of preparing the sub alloy, the “main alloy” in the following description is replaced with the “sub alloy”.

First, raw material metals corresponding to the composition of the main alloy are prepared and are melted in a vacuum or an inert gas (e.g., Ar gas) atmosphere. Then, the molten raw material metals are cast to prepare the main alloy.

The raw material metals may be of any type. Such examples can include rare earth metals, rare earth alloys, pure iron, pure cobalt, ferro-boron, their alloys, or their compounds. Casting methods of casting the raw material metals are not limited. Examples of casting methods include an ingot casting method, the strip casting method, a book molding method, and a centrifugal casting method. The resultant main alloy may undergo a homogenization treatment (solution treatment) as necessary when the main alloy has a solidification segregation.

As a method of preparing the alloy, an atomization method may be used. In this situation, the pulverization step described later may be omitted.

Note that, in a situation where a one-alloy method, in which only one alloy is prepared, is used instead of the two-alloy method, in which the main alloy and the sub alloy are prepared, the Zr—C phases are difficult to be formed. This is because of the difficulty of incorporating Zr into the main phase grains. If the one-alloy method is used, Hk/HcJ at room temperature and HcJ at high temperatures are readily decreased.

### (Pulverization Step)

A method of pulverizing the main alloy is described below. With regard to a method of pulverizing the sub alloy, the “main alloy” in the following description is replaced with the “sub alloy”.

After the main alloy is prepared, the main alloy is pulverized (pulverization step). The pulverization step may be carried out using a two-step process, which includes a coarse pulverization step of pulverizing the main alloy to a particle size of about several hundred μm to about several mm and a fine pulverization step of finely pulverizing a coarsely pulverized powder to a particle size of about several μm. However, the pulverization step may be carried out using a one-step process consisting solely of the fine pulverization step.

### (Coarse Pulverization Step)

The main alloy is coarsely pulverized until it has a particle size of about several hundred μm to about several mm (coarse pulverization step). This provides the coarsely pulverized powder of the main alloy. Coarse pulverization may be carried out using, for example, hydrogen storage pulverization. Hydrogen storage pulverization can be performed by making the main alloy store hydrogen and then release hydrogen based on a difference in the amount of stored hydrogen between different phases to bring self-collapsing pulverization. Release of hydrogen based on the difference in the amount of stored hydrogen between different phases is referred to as dehydrogenation. Dehydrogenation conditions are not limited. Dehydrogenation is performed, for example, at 300° C. to 650° C. in an argon flow or a vacuum.

Coarse pulverization methods are not limited to the above hydrogen storage pulverization. Coarse pulverization may be carried out using, for example, a coarse pulverizer (e.g., a stamp mill, a jaw crusher, and a brown mill) in an inert gas atmosphere.

For the R-T-B based permanent magnet to have high magnetic properties, the atmosphere of each step from the coarse pulverization step to the sintering step described later may be an atmosphere with a low oxygen concentration. The oxygen concentration is controlled by, for example, control of the atmosphere of each manufacturing step. If the oxygen concentration in each manufacturing step is high, a rare earth element in the alloy powder resulting from pulverization of the main alloy is oxidized to form a rare earth element oxide. The rare earth element oxide is not reduced during sintering and is deposited in the grain boundaries in the form of the rare earth element oxide. The grain boundaries are portions between two or more of the main phase grains. Consequently, Br of the resultant R-T-B based permanent magnet decreases. Thus, each step (fine pulverization step, pressing step) may be carried out in an atmosphere having an oxygen concentration of, for example, 100 ppm or less.

### (Fine Pulverization Step)

After the main alloy is coarsely pulverized, the resultant coarsely pulverized powder of the main alloy is finely pulverized until the powder has an average particle size of about several μm (fine pulverization step). This provides a finely pulverized powder of the main alloy. Further finely pulverizing the coarsely pulverized powder can provide the finely pulverized powder. D50 of the particles included in the finely pulverized powder is not limited. D50 may be, for example, 2.0 μm or more and 4.5 μm or less, or 2.5 μm or more and 3.5 μm or less. The smaller the D50, the more readily HcJ of the R-T-B based permanent magnet according to the present embodiment is improved. However, abnormal grain growth tends to occur during the sintering step, decreasing the upper limit of the sintering temperature range. The larger the D50, the less readily abnormal grain growth occurs during the sintering step, increasing the upper limit of the sintering temperature range. However, HcJ of the R-T-B based permanent magnet according to the present embodiment is readily decreased.

Fine pulverization is carried out by further pulverizing the coarsely pulverized powder using a fine pulverizer (e.g., a jet mill, a ball mill, a vibrating mill, and a wet attritor) while conditions (e.g., pulverization time) are appropriately controlled. A jet mill is described below. A jet mill is a fine pulverizer in which a high-pressure inert gas (e.g., He gas, N₂ gas, and Ar gas) is released from a narrow nozzle to generate a high-speed gas flow, which accelerates the coarsely pulverized powder of the main alloy to collide against each other or collide with a target or a container wall for pulverization.

When the coarsely pulverized powder of the main alloy is finely pulverized, a pulverization aid may be added. The pulverization aid may be of any type. For example, an organic lubricant or a solid lubricant may be used. Examples of organic lubricants include oleamide, lauramide, and zinc stearate. Examples of solid lubricants include graphite. Adding the pulverization aid can provide the finely pulverized powder that readily aligns when a magnetic field is applied in the pressing step.

### (Mixing Step)

Then, the main alloy and sub alloy are mixed to provide a pressing alloy powder (mixing step). Any mixing method may be used.

### (Pressing Step)

The pressing alloy powder is pressed into an intended shape (pressing step). In the pressing step, a mold disposed in an electromagnet is filled with the pressing alloy powder, and the powder is pressed with pressure, to provide a green compact. At this time, pressing the pressing alloy powder while a magnetic field is being applied thereto allows a crystal axis of the pressing alloy powder to be oriented in a specific direction. A pressing aid may be added. The pressing aid may be of any type. The same lubricant as the pulverization aid may be used. The pulverization aid may double as the pressing aid.

The pressure applied during pressing may be, for example, 30 MPa or more and 300 MPa or less. The magnetic field applied may be, for example, 1000 kA/m or more and 1600 kA/m or less. The magnetic field applied is not limited to a static magnetic field and can be a pulsed magnetic field. Also, a static magnetic field and a pulsed magnetic field can be used together.

As for pressing methods, other than dry pressing, in which the pressing alloy powder is directly pressed as described above, wet pressing can be used, in which slurry including a solvent (e.g., oil) and the pressing alloy powder dispersed therein is pressed.

The green compact resulting from pressing the pressing alloy powder may have any shape. The green compact can have a shape according to a desired shape of the R-T-B based permanent magnet, such as a rectangular parallelepiped shape.

### (Sintering Step)

The green compact resulting from pressing the pressing alloy powder into an intended shape in a magnetic field is sintered in a vacuum or an inert gas atmosphere to provide the R-T-B based permanent magnet (sintering step). The holding temperature (sintering temperature) and the holding time (sintering time) for sintering need to be controlled according to conditions, such as a composition, a pulverization method, and a difference in particle size and particle size distribution. The sintering temperature is not limited and may be 1040° C. or more and 1100° C. or less. The sintering time is not limited and may be 1 hour or more and 10 hours or less, 2 hours or more and 8 hours or less, or 3 hours or more and 6 hours or less. The shorter the sintering time, the higher the production efficiency. However, magnetic properties, particularly Hk/HcJ, tend to decrease. The longer the sintering time, the better the magnetic properties tend to be. However, production efficiency decreases.

The sintering atmosphere is not limited. The atmosphere may be, for example, an inert gas atmosphere, a less than 100 Pa vacuum atmosphere, or a less than 10 Pa vacuum atmosphere. The heating rate to reach the sintering temperature and the cooling rate after the green compact is sintered to provide a sintered body are not limited.

### (Aging Treatment Step)

After the green compact is sintered, the R-T-B permanent magnet is age-treated (aging treatment step). After sintering, the resultant R-T-B based permanent magnet may undergo an aging treatment, in which, for example, the R-T-B based permanent magnet is held at a temperature lower than that of sintering. Described below is the aging treatment performed in two stages, which are a first aging treatment and a second aging treatment. However, only either one of them may be performed, or the aging treatment in three or more stages may be performed.

The holding temperature and the holding time of each aging treatment are not limited. The first aging treatment may be performed, for example, at a holding temperature of 800° C. or more and 900° C. or less for 30 minutes or more and 4 hours or less. The heating rate to reach the holding temperature may be 5° C./min or more and 50° C./min or less. The atmosphere of the first aging treatment may be an inert gas atmosphere (e.g., He gas or Ar gas) under at least atmospheric pressure. The second aging treatment may be performed under the same conditions as those of the first aging treatment except that the holding temperature may be 450° C. or more and 550° C. or less. The aging treatment can improve the magnetic properties of the R-T-B based permanent magnet. The aging treatment step may be performed after the machining step described later.

### (Cooling Step)

After the aging treatment (the first aging treatment or the second aging treatment) of the R-T-B based permanent magnet, the R-T-B based permanent magnet is rapidly cooled in an inert gas atmosphere (cooling step). The cooling rate is not limited.

### (Machining Step)

The resultant R-T-B based permanent magnet may be machined into a desired shape as necessary (machining step). Examples of machining methods include shape machining (e.g., cutting or grinding) and chamfering (e.g., barrel polishing).

### (Grain Boundary Diffusion Step)

Further, a heavy rare earth element(s) is diffused to the grain boundaries of the machined R-T-B based permanent magnet (grain boundary diffusion step). Methods of grain boundary diffusion are not limited. Grain boundary diffusion may be carried out through, for example, application, deposition, or the like such that a compound containing the heavy rare earth element(s) adheres to surfaces of the R-T-B based permanent magnet and then a heat treatment. Alternatively, grain boundary diffusion may be carried out by performing a heat treatment to the R-T-B based permanent magnet in an atmosphere containing a vapor of the heavy rare earth element(s). Grain boundary diffusion can further improve HcJ of the R-T-B based permanent magnet.

### (Surface Treatment Step)

The R-T-B based permanent magnet resulting from the above steps may undergo surface treatments, such as plating, resin coating, an oxidizing treatment, and a chemical treatment (surface treatment step). This can further improve the corrosion resistance.

In the above method of manufacturing the R-T-B based permanent magnet, it is important that the composition of the main alloy, the microstructure of the main alloy, the composition of the sub alloy, and the mix ratio of the main alloy to the sub alloy are appropriately controlled. The main alloy is an alloy that eventually becomes mainly the main phase grains 11. The sub alloy is an alloy that eventually becomes mainly the grain boundaries 13.

### (Composition of Main Alloy)

The composition of the main alloy is not limited except that the main alloy has a B content of 0.97 mass % or more and 1.11 mass % or less. Other than the B content, the main alloy may have, out of 100 mass % of the main alloy, for example,
a total light rare earth element content of 28.00 mass % or more and 32.00 mass % or less,
a total heavy rare earth element content of 0 mass % or more and 1.00 mass % or less,
an Al content of 0.04 mass % or more and 0.57 mass % or less,
a Ga content of 0 mass % or more and 0.25 mass % or less,
a Cu content of 0 mass % or more and 0.50 mass % or less,
a Co content of 0 mass % or more and 3.00 mass % or less, and
a Zr content of 0.25 mass % or more and 0.74 mass % or less.

“Out of 100 mass % of the main alloy” means that the total content of all elements is 100 mass %. The Fe content of the main alloy may substantially be the balance of the main alloy. Specifically, the content of each element other than rare earth elements, Fe, Co, B, Al, Ga, Zr, Cu, and C may be 0.20 mass % or less, or their total may be 1.00 mass % or less.

### (Composition of Sub Alloy)

The composition of the sub alloy is not limited except that the sub alloy has a Zr content of 0.96 mass % or more and 15.0 mass % or less. Other than the Zr content, the sub alloy may have, out of 100 mass % of the sub alloy, for example,
a total heavy rare earth element content of 0 mass % or more and 1.00 mass % or less,
an Al content of 0 mass % or more and 0.90 mass % or less,
a Ga content of 0 mass % or more and 9.50 mass % or less,
a Cu content of 0 mass % or more and 6.00 mass % or less, and
a Co content of 2.00 mass % or more and 9.50 mass % or less.

“Out of 100 mass % of the sub alloy” means that the total content of all elements is 100 mass %. The Fe content of the sub alloy may substantially be the balance of the sub alloy. Specifically, the content of each element other than rare earth elements, Fe, Al, Ga, Cu, Co, and Zr may be 0.20 mass % or less, or their total may be 1.00 mass % or less.

### (Mix Ratio of Main Alloy to Sub Alloy)

The main alloy and the sub alloy are mixed at any ratio and may be mixed at a ratio of 88:12 to 97:3 based on mass. In a situation where the R-T-B based permanent magnet eventually manufactured contains too less main alloy compared to another R-T-B based permanent magnet with a composition close to that of the former magnet, the former R-T-B based permanent magnet tends to have lower Hk/HcJ. In a situation where the R-T-B based permanent magnet eventually manufactured contains too much main alloy compared to another R-T-B based permanent magnet with a composition close to that of the former magnet, the former R-T-B based permanent magnet tends to have lower magnetic properties, particularly lower HcJ at room temperature, lower Hk/HcJ at room temperature, and lower HcJ at high temperatures.

The R-T-B based permanent magnet resulting as above has good magnetic properties. That is, the R-T-B based permanent magnet having high magnetic properties in spite of relatively small heavy rare earth element usage can be manufactured.

The present disclosure is not limited to the above embodiment and can variously be modified within the scope of the present disclosure.

### EXAMPLES

Hereinafter, the present disclosure is described in further detail using examples. However, the present disclosure is not limited to these examples.

### (Alloy Preparation Step)

In an alloy preparation step, a main alloy having a composition shown in Table 1, Table 5, Table 9, Table 13, or Table 17 (which may hereinafter be referred to as Table 1 or the like) and a sub alloy having a composition shown in Table 2, Table 6, Table 10, Table 14, or Table 18 (which may hereinafter be referred to as Table 2 or the like) were prepared. “TRL” means the total light rare earth element content. The content of all elements other than Fe not shown in each table was less than 0.01 mass % each. That is, Fe was substantially the balance of the alloy shown in each table.

First, raw material metals containing predetermined elements were prepared. As the raw material metals, for example, a simple substance of an element shown in each table, an alloy containing elements shown in each table, and/or a compound containing elements shown in each table were appropriately selected and prepared.

Then, these raw material metals were weighed, and a strip casting method was used to prepare the main alloy and the sub alloy.

### (Pulverization Step)

In a pulverization step, each alloy resulting from the alloy preparation step was pulverized to provide an alloy powder. Pulverization was carried out in two steps, which were coarse pulverization and fine pulverization. Coarse pulverization was carried out using hydrogen storage pulverization. After each alloy stored hydrogen, dehydrogenation was performed in an argon flow or a vacuum at 300° C. to 600° C. Coarse pulverization provided an alloy powder having a particle size of about several hundred μm to about several mm.

After oleamide was added as a pulverization aid to the alloy powder resulting from coarse pulverization and was mixed with the powder, fine pulverization was carried out with a jet mill. The amount of the pulverization aid added was determined so that a magnet eventually obtained had a carbon content, a nitrogen content, and an oxygen content shown in Table 4, Table 8, Table 12, Table 16, or Table 20 (which may hereinafter be referred to as Table 4 or the like). For the jet mill, a nitrogen gas was used. Fine pulverization was carried out until the alloy powder had a D50 of about 3.0 μm.

### (Mixing Step)

A main alloy powder resulting from pulverizing the main alloy shown in Table 1 or the like and a sub alloy powder resulting from pulverizing the sub alloy shown in Table 2 or the like were mixed at a mix ratio shown in Table 3, Table 7, Table 11, Table 15, or Table 19 (which may hereinafter be referred to as Table 3 or the like) to provide a pressing alloy powder. In Table 3 or the like, the mix ratio is shown in the form of the main alloy powder:the sub alloy powder.

### (Pressing Step)

In a pressing step, the pressing alloy powder resulting from the pulverization step and the mixing step was pressed in a magnetic field to provide a green compact. After a mold disposed in an electromagnet was filled with the alloy powder, the powder was pressed with pressure while a magnetic field was applied using the electromagnet. The magnetic field applied was 1200 kA/m. The pressure applied during pressing was 40 MPa.

### (Sintering Step)

In a sintering step, the resultant green compact was sintered to provide a sintered body. The holding temperature for sintering (sintering temperature) was 1080° C. The holding time for sintering (sintering time) was 4 hours. The heating rate to reach the holding temperature was 8.0° C./min. The cooling rate to cool from the holding temperature to room temperature was 50° C./min. The sintering atmosphere was a vacuum atmosphere or an inert gas atmosphere.

### (Aging Treatment Step)

In an aging treatment step, the resultant sintered body underwent an aging treatment. The aging treatment was performed in two stages, which were a first aging treatment and a second aging treatment.

In the first aging treatment, the heating rate to reach the holding temperature was 8.0° C./min. The holding temperature was 900° C. The holding time was 1.0 hour. The cooling rate to cool from the holding temperature to room temperature was 50° C./min. The atmosphere of the first aging treatment was an Ar atmosphere.

In the second aging treatment, the heating rate to reach the holding temperature was 8.0° C./min. The holding temperature was 500° C. The holding time was 1.5 hours. The cooling rate to cool from the holding temperature to room temperature was 50° C./min. The atmosphere of the second aging treatment was an Ar atmosphere.

### (Grain Boundary Diffusion Step)

In a grain boundary diffusion step, Tb as a heavy rare earth element was diffused to the sintered body after the aging treatment.

First, a diffusing material paste was prepared. A hydrogen gas flowed to metal Tb with a purity of 99.9% so that it stored hydrogen. Then, the atmosphere was switched to an Ar gas, and a dehydrogenation treatment was performed at 600° C. for 1 hour for hydrogen storage pulverization of metal Tb. Then, 0.05 mass % zinc stearate was added as a pulverization aid to 100 mass % metal Tb, and they were mixed with a Nauta mixer. Then, fine pulverization was carried out using a jet mill in an atmosphere with 3000 ppm oxygen to provide a finely pulverized powder of a Tb hydride having an average particle size of about 10.0 μm.

The finely pulverized powder of the Tb hydride (75.0 parts by mass), alcohol (23.0 parts by mass), and acrylic resin (2.0 parts by mass) were kneaded to prepare the diffusing material paste. The alcohol was a solvent. The acrylic resin was a binder.

An etching treatment was performed, in which the sintered body after the aging treatment was immersed in a mixed solution including 100 parts by mass ethanol and 3 parts by mass nitric acid for 3 minutes and then in ethanol for 1 minute. This etching treatment, in which the sintered body was immersed in the mixed solution for 3 minutes and then in ethanol for 1 minute, was performed twice.

Then, the above diffusing material paste was applied to all surfaces of the sintered body after the etching treatment. The amount of the diffusing material paste applied was determined so that the composition of the R-T-B based permanent magnet eventually obtained was as shown in Table 3 or the like and Table 4 or the like.

Then, the sintered body to which the diffusing material paste was applied was left in an oven at 160° C. to remove the solvent included in the diffusing material paste. Then, while Ar flowed under atmospheric pressure (1 atm), the sintered body was heated for 18 hours at 930° C. Then, while Ar flowed under atmospheric pressure, the sintered body was heated for 4 hours at 520° C. to 560° C. From the above, the R-T-B based permanent magnet having a composition shown in Table 3 or the like and Table 4 or the like was manufactured.

The surfaces of the R-T-B based permanent magnet were scraped off by 0.1 mm each. Then, the composition, sinterability, and magnetic properties were evaluated.

Through a compositional analysis using a fluorescent X-ray analysis, an inductively coupled plasma emission spectroscopic analysis (ICP analysis), and a gas analysis, it was confirmed that the composition of the R-T-B based permanent magnet eventually manufactured for each Example or Comparative Example was as shown in Table 3 or the like and Table 4 or the like. In particular, the C content was measured using a combustion in oxygen airflow-infrared absorption method. The B content was measured using the ICP analysis. The O content was measured using an inert gas fusion-infrared absorption method. The N content was measured using an inert gas fusion-thermal conductivity method.

Table 3 or the like shows the content of elements other than O, C, and N. Table 4 or the like shows the O content, the C content, and the N content. In Table 3 or the like, TRL indicates the total light rare earth element content. TRH indicates the total heavy rare earth element content. Because no heavy rare earth element other than Tb was used in all Examples and Comparative Examples, TRH was equivalent to the Tb content in all Examples and Comparative Examples. TRE indicates the total rare earth element content. The content of each element not shown in Table 3 or the like other than Fe, C, N, and O was less than 0.01 mass %. Table 4 or the like shows the C content, the N content, and the O content in units of mass ppm. That is, in the magnet shown in Table 3 or the like and Table 4 or the like, Fe was substantially the balance.

Sample No. 80 shown in Tables 17 to 20 was prepared using a one-alloy method, in which no sub alloy was used and only a main alloy was used.

### (Evaluation)

Br at room temperature, HcJ at 160° C., and Hk/HcJ of the R-T-B based permanent magnet of each Example or Comparative Example were measured using a B—H tracer. HcJ at room temperature of the R-T-B based permanent magnet of each Example or Comparative Example was measured using a pulsed excitation magnetic property measuring apparatus. Table 4 or the like shows the results.

Br was deemed good when Br at room temperature was 1415 mT or more. HcJ was deemed good when HcJ at room temperature was 1760 kA/m or more. Hk/HcJ was deemed good when Hk/HcJ at room temperature was 95.0% or more. HcJ at high temperatures was deemed good when HcJ at 160° C. was 715 kA/m or more.

TABLE 1

| Sample | Main alloy composition (mass %) | | | | | | | | | |
|---|---|---|---|---|---|---|---|---|---|---|
| No. | Nd | Pr | TRL | B | Al | Ga | Cu | Co | Zr | Fe |
| 1 | 25.49 | 6.58 | 32.06 | 1.06 | 0.13 | 0.08 | 0.19 | 0.51 | 0.38 | Bal. |
| 2 | 25.09 | 6.47 | 31.56 | 1.06 | 0.13 | 0.08 | 0.19 | 0.51 | 0.38 | Bal. |
| 3 | 24.69 | 6.37 | 31.06 | 1.06 | 0.13 | 0.08 | 0.19 | 0.51 | 0.38 | Bal. |
| 4 | 24.29 | 6.27 | 30.56 | 1.06 | 0.13 | 0.08 | 0.19 | 0.51 | 0.38 | Bal. |
| 5 | 23.69 | 6.12 | 29.81 | 1.06 | 0.13 | 0.08 | 0.19 | 0.51 | 0.38 | Bal. |
| 6 | 23.50 | 6.06 | 29.56 | 1.06 | 0.13 | 0.08 | 0.19 | 0.51 | 0.38 | Bal. |
| 7 | 23.10 | 5.96 | 29.06 | 1.06 | 0.13 | 0.08 | 0.19 | 0.51 | 0.38 | Bal. |
| 8 | 22.70 | 5.86 | 28.56 | 1.06 | 0.13 | 0.08 | 0.19 | 0.51 | 0.38 | Bal. |
| 9 | 22.30 | 5.76 | 28.06 | 1.06 | 0.13 | 0.08 | 0.19 | 0.51 | 0.38 | Bal. |
| 10 | 21.90 | 5.66 | 27.56 | 1.06 | 0.13 | 0.08 | 0.19 | 0.51 | 0.38 | Bal. |
| 11 | 29.81 | 0.00 | 29.81 | 1.06 | 0.13 | 0.08 | 0.19 | 0.51 | 0.38 | Bal. |
| 12 | 29.78 | 0.03 | 29.81 | 1.06 | 0.13 | 0.08 | 0.19 | 0.51 | 0.38 | Bal. |
| 13 | 29.51 | 0.30 | 29.81 | 1.06 | 0.13 | 0.08 | 0.19 | 0.51 | 0.38 | Bal. |
| 14 | 28.81 | 1.00 | 29.81 | 1.06 | 0.13 | 0.08 | 0.19 | 0.51 | 0.38 | Bal. |
| 15 | 24.80 | 5.01 | 29.81 | 1.06 | 0.13 | 0.08 | 0.19 | 0.51 | 0.38 | Bal. |
| 5 | 23.69 | 6.12 | 29.81 | 1.06 | 0.13 | 0.08 | 0.19 | 0.51 | 0.38 | Bal. |
| 16 | 22.39 | 7.41 | 29.81 | 1.06 | 0.13 | 0.08 | 0.19 | 0.51 | 0.38 | Bal. |
| 17 | 19.79 | 10.02 | 29.81 | 1.06 | 0.13 | 0.08 | 0.19 | 0.51 | 0.38 | Bal. |

TABLE 2

| Sample | Sub alloy composition (mass %) | | | | | | | | | |
|---|---|---|---|---|---|---|---|---|---|---|
| No. | Nd | Pr | TRL | B | Al | Ga | Cu | Co | Zr | Fe |
| 1 | 25.49 | 6.58 | 32.06 | 0.00 | 0.10 | 0.00 | 0.06 | 5.11 | 5.34 | Bal. |
| 2 | 25.09 | 6.47 | 31.56 | 0.00 | 0.10 | 0.00 | 0.06 | 5.11 | 5.34 | Bal. |
| 3 | 24.69 | 6.37 | 31.06 | 0.00 | 0.10 | 0.00 | 0.06 | 5.11 | 5.34 | Bal. |
| 4 | 24.29 | 6.27 | 30.56 | 0.00 | 0.10 | 0.00 | 0.06 | 5.11 | 5.34 | Bal. |
| 5 | 23.69 | 6.12 | 29.81 | 0.00 | 0.10 | 0.00 | 0.06 | 5.11 | 5.34 | Bal. |
| 6 | 23.50 | 6.06 | 29.56 | 0.00 | 0.10 | 0.00 | 0.06 | 5.11 | 5.34 | Bal. |
| 7 | 23.10 | 5.96 | 29.06 | 0.00 | 0.10 | 0.00 | 0.06 | 5.11 | 5.34 | Bal. |
| 8 | 22.70 | 5.86 | 28.56 | 0.00 | 0.10 | 0.00 | 0.06 | 5.11 | 5.34 | Bal. |
| 9 | 22.30 | 5.76 | 28.06 | 0.00 | 0.10 | 0.00 | 0.06 | 5.11 | 5.34 | Bal. |
| 10 | 21.90 | 5.66 | 27.56 | 0.00 | 0.10 | 0.00 | 0.06 | 5.11 | 5.34 | Bal. |
| 11 | 29.81 | 0.00 | 29.81 | 0.00 | 0.10 | 0.00 | 0.06 | 5.11 | 5.34 | Bal. |
| 12 | 29.78 | 0.03 | 29.81 | 0.00 | 0.10 | 0.00 | 0.06 | 5.11 | 5.34 | Bal. |
| 13 | 29.52 | 0.29 | 29.81 | 0.00 | 0.10 | 0.00 | 0.06 | 5.11 | 5.34 | Bal. |
| 14 | 28.86 | 0.95 | 29.81 | 0.00 | 0.10 | 0.00 | 0.06 | 5.11 | 5.34 | Bal. |
| 15 | 25.05 | 4.76 | 29.81 | 0.00 | 0.10 | 0.00 | 0.06 | 5.11 | 5.34 | Bal. |
| 5 | 23.69 | 6.12 | 29.81 | 0.00 | 0.10 | 0.00 | 0.06 | 5.11 | 5.34 | Bal. |
| 16 | 22.77 | 7.04 | 29.81 | 0.00 | 0.10 | 0.00 | 0.06 | 5.11 | 5.34 | Bal. |
| 17 | 20.29 | 9.52 | 29.81 | 0.00 | 0.10 | 0.00 | 0.06 | 5.11 | 5.34 | Bal. |

TABLE 3

| | | Mix ratio | Magnet composition (mass %) | | | | | | | | | | | |
|---|---|---|---|---|---|---|---|---|---|---|---|---|---|---|
| Sample | Example/ | (based on | | | | Tb | | | | | | | | |
| No. | Comparative Example | mass) | Nd | Pr | TRL | (TRH) | TRE | B | Al | Ga | Cu | Co | Zr | Fe |
| 1 | Comparative Example | 95:5 | 25.44 | 6.56 | 32.00 | 0.20 | 32.20 | 1.00 | 0.13 | 0.08 | 0.18 | 0.74 | 0.63 | Bal. |
| 2 | Example | 95:5 | 25.04 | 6.46 | 31.50 | 0.20 | 31.70 | 1.00 | 0.13 | 0.08 | 0.18 | 0.74 | 0.63 | Bal. |
| 3 | Example | 95:5 | 24.64 | 6.36 | 31.00 | 0.20 | 31.20 | 1.00 | 0.13 | 0.08 | 0.18 | 0.74 | 0.63 | Bal. |
| 4 | Example | 95:5 | 24.24 | 6.26 | 30.50 | 0.20 | 30.70 | 1.00 | 0.13 | 0.08 | 0.18 | 0.74 | 0.63 | Bal. |
| 5 | Example | 95:5 | 23.65 | 6.10 | 29.75 | 0.20 | 29.95 | 1.00 | 0.13 | 0.08 | 0.18 | 0.74 | 0.63 | Bal. |
| 6 | Example | 95:5 | 23.45 | 6.05 | 29.50 | 0.20 | 29.70 | 1.00 | 0.13 | 0.08 | 0.18 | 0.74 | 0.63 | Bal. |
| 7 | Example | 95:5 | 23.05 | 5.95 | 29.00 | 0.20 | 29.20 | 1.00 | 0.13 | 0.08 | 0.18 | 0.74 | 0.63 | Bal. |
| 8 | Example | 95:5 | 22.65 | 5.85 | 28.50 | 0.20 | 28.70 | 1.00 | 0.13 | 0.08 | 0.18 | 0.74 | 0.63 | Bal. |
| 9 | Example | 95:5 | 22.26 | 5.74 | 28.00 | 0.20 | 28.20 | 1.00 | 0.13 | 0.08 | 0.18 | 0.74 | 0.63 | Bal. |
| 10 | Comparative Example | 95:5 | Sintering impossible | | | | | | | | | | | |
| 11 | Example | 95:5 | 29.80 | 0.00 | 29.80 | 0.20 | 30.00 | 1.00 | 0.13 | 0.08 | 0.18 | 0.74 | 0.63 | Bal. |
| 12 | Example | 95:5 | 29.67 | 0.03 | 29.70 | 0.20 | 29.90 | 1.00 | 0.13 | 0.08 | 0.18 | 0.74 | 0.63 | Bal. |
| 13 | Example | 95:5 | 29.49 | 0.30 | 29.79 | 0.20 | 29.99 | 1.00 | 0.13 | 0.08 | 0.18 | 0.74 | 0.63 | Bal. |
| 14 | Example | 95:5 | 28.77 | 1.00 | 29.77 | 0.20 | 29.97 | 1.00 | 0.13 | 0.08 | 0.18 | 0.74 | 0.63 | Bal. |
| 15 | Example | 95:5 | 24.77 | 5.00 | 29.77 | 0.20 | 29.97 | 1.00 | 0.13 | 0.08 | 0.18 | 0.74 | 0.63 | Bal. |
| 5 | Example | 95:5 | 23.65 | 6.10 | 29.75 | 0.20 | 29.95 | 1.00 | 0.13 | 0.08 | 0.18 | 0.74 | 0.63 | Bal. |
| 16 | Example | 95:5 | 22.30 | 7.40 | 29.70 | 0.20 | 29.90 | 1.00 | 0.13 | 0.08 | 0.18 | 0.74 | 0.63 | Bal. |
| 17 | Example | 95:5 | 19.71 | 10.00 | 29.71 | 0.20 | 29.91 | 1.00 | 0.13 | 0.08 | 0.18 | 0.74 | 0.63 | Bal. |

TABLE 4

| | | | | | | | | 160° C. |
|---|---|---|---|---|---|---|---|---|
| Sample | Example/ | CNO content (ppm) | | | Br | HcJ | Hk/HcJ | HcJ |
| No. | Comparative Example | C | N | O | (mT) | (kA/m) | (%) | (kA/m) |
| 1 | Comparative Example | 908 | 508 | 500 | 1398 | 2045 | 98.7 | 821 |
| 2 | Example | 905 | 505 | 504 | 1424 | 2019 | 98.5 | 810 |
| 3 | Example | 904 | 500 | 502 | 1430 | 1994 | 99.5 | 798 |
| 4 | Example | 900 | 501 | 501 | 1444 | 1968 | 98.4 | 786 |
| 5 | Example | 903 | 502 | 502 | 1458 | 1943 | 97.4 | 775 |
| 6 | Example | 902 | 504 | 504 | 1465 | 1917 | 98.4 | 763 |
| 7 | Example | 901 | 503 | 502 | 1480 | 1892 | 99.2 | 752 |
| 8 | Example | 900 | 505 | 504 | 1495 | 1879 | 99.5 | 740 |
| 9 | Example | 905 | 505 | 500 | 1510 | 1866 | 98.5 | 729 |
| 10 | Comparative Example | Sintering impossible | | | | | | |
| 11 | Example | 902 | 501 | 504 | 1475 | 1778 | 99.5 | 772 |
| 12 | Example | 901 | 503 | 500 | 1473 | 1798 | 97.8 | 783 |
| 13 | Example | 903 | 503 | 501 | 1471 | 1820 | 96.8 | 781 |
| 14 | Example | 905 | 501 | 504 | 1468 | 1829 | 98.8 | 780 |
| 15 | Example | 903 | 505 | 505 | 1459 | 1936 | 96.5 | 777 |
| 5 | Example | 903 | 502 | 502 | 1458 | 1943 | 99.4 | 775 |
| 16 | Example | 901 | 503 | 502 | 1456 | 1950 | 97.8 | 773 |
| 17 | Example | 902 | 504 | 504 | 1455 | 1970 | 98.7 | 770 |

TABLE 5

| Sample | Main alloy composition (mass %) | | | | | | | | | |
|---|---|---|---|---|---|---|---|---|---|---|
| No. | Nd | Pr | TRL | B | Al | Ga | Cu | Co | Zr | Fe |
| 21 | 23.67 | 6.11 | 29.78 | 1.05 | 0.13 | 0.08 | 0.19 | 0.51 | 0.38 | Bal. |
| 22 | 23.68 | 6.11 | 29.79 | 1.05 | 0.13 | 0.08 | 0.19 | 0.51 | 0.38 | Bal. |
| 5 | 23.69 | 6.12 | 29.81 | 1.06 | 0.13 | 0.08 | 0.19 | 0.51 | 0.38 | Bal. |
| 23 | 23.71 | 6.12 | 29.82 | 1.06 | 0.13 | 0.08 | 0.19 | 0.51 | 0.38 | Bal. |
| 24 | 23.72 | 6.12 | 29.84 | 1.06 | 0.13 | 0.08 | 0.19 | 0.51 | 0.38 | Bal. |
| 25 | 23.74 | 6.13 | 29.87 | 1.06 | 0.13 | 0.08 | 0.19 | 0.51 | 0.38 | Bal. |
| 26 | 23.77 | 6.13 | 29.90 | 1.06 | 0.13 | 0.08 | 0.19 | 0.51 | 0.38 | Bal. |
| 27 | 23.79 | 6.14 | 29.93 | 1.06 | 0.13 | 0.08 | 0.19 | 0.51 | 0.39 | Bal. |
| 28 | 23.82 | 6.15 | 29.97 | 1.06 | 0.13 | 0.08 | 0.19 | 0.51 | 0.39 | Bal. |
| 29 | 23.84 | 6.15 | 29.99 | 1.06 | 0.13 | 0.08 | 0.19 | 0.51 | 0.39 | Bal. |
| 31 | 23.69 | 6.12 | 29.81 | 1.06 | 0.13 | 0.08 | 0.19 | 0.51 | 0.19 | Bal. |
| 32 | 23.69 | 6.12 | 29.81 | 1.06 | 0.13 | 0.08 | 0.19 | 0.51 | 0.24 | Bal. |
| 33 | 23.69 | 6.12 | 29.81 | 1.02 | 0.13 | 0.08 | 0.19 | 0.51 | 0.26 | Bal. |
| 34 | 23.69 | 6.12 | 29.81 | 1.06 | 0.13 | 0.08 | 0.19 | 0.51 | 0.26 | Bal. |
| 35 | 23.69 | 6.12 | 29.81 | 1.06 | 0.13 | 0.08 | 0.19 | 0.51 | 0.28 | Bal. |
| 36 | 23.69 | 6.12 | 29.81 | 1.06 | 0.13 | 0.08 | 0.19 | 0.51 | 0.31 | Bal. |
| 5 | 23.69 | 6.12 | 29.81 | 1.06 | 0.13 | 0.08 | 0.19 | 0.51 | 0.38 | Bal. |
| 37 | 23.69 | 6.12 | 29.81 | 1.06 | 0.13 | 0.08 | 0.19 | 0.51 | 0.45 | Bal. |
| 38 | 23.69 | 6.12 | 29.81 | 1.06 | 0.13 | 0.08 | 0.19 | 0.51 | 0.51 | Bal. |
| 39 | 23.69 | 6.12 | 29.81 | 1.06 | 0.13 | 0.08 | 0.19 | 0.51 | 0.56 | Bal. |

TABLE 6

| Sample | Sub alloy composition (mass %) | | | | | | | | | |
|---|---|---|---|---|---|---|---|---|---|---|
| No. | Nd | Pr | TRL | B | Al | Ga | Cu | Co | Zr | Fe |
| 21 | 23.67 | 6.11 | 29.78 | 0.00 | 0.10 | 0.00 | 0.06 | 5.11 | 5.34 | Bal. |
| 22 | 23.68 | 6.11 | 29.79 | 0.00 | 0.10 | 0.00 | 0.06 | 5.12 | 5.35 | Bal. |
| 5 | 23.69 | 6.12 | 29.81 | 0.00 | 0.10 | 0.00 | 0.06 | 5.12 | 5.35 | Bal. |
| 23 | 23.71 | 6.12 | 29.82 | 0.00 | 0.10 | 0.00 | 0.06 | 5.12 | 5.35 | Bal. |
| 24 | 23.72 | 6.12 | 29.84 | 0.00 | 0.10 | 0.00 | 0.06 | 5.13 | 5.36 | Bal. |
| 25 | 23.74 | 6.13 | 29.87 | 0.00 | 0.10 | 0.00 | 0.06 | 5.13 | 5.36 | Bal. |
| 26 | 23.77 | 6.13 | 29.90 | 0.00 | 0.10 | 0.00 | 0.06 | 5.14 | 5.37 | Bal. |
| 27 | 23.79 | 6.14 | 29.93 | 0.00 | 0.10 | 0.00 | 0.06 | 5.14 | 5.37 | Bal. |
| 28 | 23.82 | 6.15 | 29.97 | 0.00 | 0.10 | 0.00 | 0.06 | 5.15 | 5.38 | Bal. |
| 29 | 23.84 | 6.15 | 29.99 | 0.00 | 0.10 | 0.00 | 0.06 | 5.15 | 5.38 | Bal. |
| 31 | 23.69 | 6.12 | 29.81 | 0.00 | 0.10 | 0.00 | 0.06 | 5.11 | 5.34 | Bal. |
| 32 | 23.69 | 6.12 | 29.81 | 0.00 | 0.10 | 0.00 | 0.06 | 5.11 | 5.34 | Bal. |
| 33 | 23.69 | 6.12 | 29.81 | 0.00 | 0.10 | 0.00 | 0.06 | 5.11 | 5.34 | Bal. |
| 34 | 23.69 | 6.12 | 29.81 | 0.00 | 0.10 | 0.00 | 0.06 | 5.11 | 5.34 | Bal. |
| 35 | 23.69 | 6.12 | 29.81 | 0.00 | 0.10 | 0.00 | 0.06 | 5.11 | 5.34 | Bal. |
| 36 | 23.69 | 6.12 | 29.81 | 0.00 | 0.10 | 0.00 | 0.06 | 5.11 | 5.34 | Bal. |
| 5 | 23.69 | 6.12 | 29.81 | 0.00 | 0.10 | 0.00 | 0.06 | 5.11 | 5.34 | Bal. |
| 37 | 23.69 | 6.12 | 29.81 | 0.00 | 0.10 | 0.00 | 0.06 | 5.11 | 5.34 | Bal. |
| 38 | 23.69 | 6.12 | 29.81 | 0.00 | 0.10 | 0.00 | 0.06 | 5.11 | 5.34 | Bal. |
| 39 | 23.69 | 6.12 | 29.81 | 0.00 | 0.10 | 0.00 | 0.06 | 5.11 | 5.34 | Bal. |

TABLE 7

| | | Mix ratio | Magnet composition (mass %) | | | | | | | | | | | |
|---|---|---|---|---|---|---|---|---|---|---|---|---|---|---|
| Sample | Example/ | (based | | | | Tb | | | | | | | | |
| No. | Comparative Example | on mass) | Nd | Pr | TRL | (TRH) | TRE | B | Al | Ga | Cu | Co | Zr | Fe |
| 21 | Example | 95:5 | 23.66 | 6.10 | 29.74 | 0.10 | 29.86 | 1.00 | 0.13 | 0.08 | 0.18 | 0.74 | 0.63 | Bal. |
| 22 | Example | 95:5 | 23.69 | 6.11 | 29.72 | 0.15 | 29.95 | 1.00 | 0.13 | 0.08 | 0.18 | 0.74 | 0.63 | Bal. |
| 5 | Example | 95:5 | 23.65 | 6.10 | 29.75 | 0.20 | 29.95 | 1.00 | 0.13 | 0.08 | 0.18 | 0.74 | 0.63 | Bal. |
| 23 | Example | 95:5 | 23.61 | 6.09 | 29.70 | 0.25 | 29.95 | 1.00 | 0.13 | 0.08 | 0.18 | 0.74 | 0.63 | Bal. |
| 24 | Example | 95:5 | 23.62 | 6.10 | 29.80 | 0.30 | 30.02 | 1.00 | 0.13 | 0.08 | 0.18 | 0.74 | 0.63 | Bal. |
| 25 | Example | 95:5 | 23.61 | 6.09 | 29.80 | 0.40 | 30.10 | 1.00 | 0.13 | 0.08 | 0.18 | 0.74 | 0.63 | Bal. |
| 26 | Example | 95:5 | 23.65 | 6.10 | 29.80 | 0.50 | 30.25 | 1.00 | 0.13 | 0.08 | 0.18 | 0.74 | 0.63 | Bal. |
| 27 | Example | 95:5 | 23.62 | 6.10 | 29.71 | 0.60 | 30.32 | 1.00 | 0.13 | 0.08 | 0.18 | 0.74 | 0.63 | Bal. |
| 28 | Example | 95:5 | 23.69 | 6.11 | 29.78 | 0.75 | 30.55 | 1.00 | 0.13 | 0.08 | 0.18 | 0.74 | 0.63 | Bal. |
| 29 | Example | 95:5 | 23.67 | 6.11 | 29.80 | 0.80 | 30.58 | 1.00 | 0.13 | 0.08 | 0.18 | 0.74 | 0.63 | Bal. |
| 31 | Comparative Example | 95:5 | 23.64 | 6.10 | 29.74 | 0.20 | 29.94 | 1.00 | 0.13 | 0.08 | 0.18 | 0.74 | 0.45 | Bal. |
| 32 | Comparative Example | 95:5 | 23.66 | 6.11 | 29.77 | 0.20 | 29.97 | 1.00 | 0.13 | 0.08 | 0.18 | 0.74 | 0.49 | Bal. |
| 33 | Example | 95:5 | 23.67 | 6.11 | 29.78 | 0.20 | 29.98 | 0.99 | 0.13 | 0.08 | 0.18 | 0.74 | 0.51 | Bal. |
| 34 | Example | 95:5 | 23.69 | 6.11 | 29.80 | 0.20 | 30.00 | 1.00 | 0.13 | 0.08 | 0.18 | 0.74 | 0.51 | Bal. |
| 35 | Example | 95:5 | 23.67 | 6.11 | 29.78 | 0.20 | 29.98 | 0.97 | 0.13 | 0.08 | 0.18 | 0.74 | 0.53 | Bal. |
| 36 | Example | 95:5 | 23.62 | 6.09 | 29.71 | 0.20 | 29.91 | 1.00 | 0.13 | 0.08 | 0.18 | 0.74 | 0.57 | Bal. |
| 5 | Example | 95:5 | 23.65 | 6.10 | 29.75 | 0.20 | 29.95 | 1.00 | 0.13 | 0.08 | 0.18 | 0.74 | 0.63 | Bal. |
| 37 | Example | 95:5 | 23.65 | 6.10 | 29.75 | 0.20 | 29.95 | 1.00 | 0.13 | 0.08 | 0.18 | 0.74 | 0.69 | Bal. |
| 38 | Example | 95:5 | 23.69 | 6.11 | 29.80 | 0.20 | 30.00 | 1.00 | 0.13 | 0.08 | 0.18 | 0.74 | 0.74 | Bal. |
| 39 | Comparative Example | 95:5 | 23.66 | 6.10 | 29.76 | 0.20 | 29.96 | 1.00 | 0.13 | 0.08 | 0.18 | 0.74 | 0.80 | Bal. |

TABLE 8

| | | | | | | | | 160° C. |
|---|---|---|---|---|---|---|---|---|
| Sample | Example/ | CNO content (ppm) | | | Br | HcJ | Hk/HcJ | HcJ |
| No. | Comparative Example | C | N | O | (mT) | (kA/m) | (%) | (kA/m) |
| 21 | Example | 901 | 503 | 505 | 1461 | 1906 | 98.7 | 746 |
| 22 | Example | 903 | 501 | 505 | 1460 | 1918 | 99.3 | 755 |
| 5 | Example | 903 | 502 | 502 | 1458 | 1943 | 97.4 | 775 |
| 23 | Example | 903 | 502 | 502 | 1457 | 1949 | 98.4 | 780 |
| 24 | Example | 901 | 505 | 504 | 1456 | 1955 | 96.8 | 785 |
| 25 | Example | 903 | 502 | 504 | 1454 | 1980 | 96.8 | 804 |
| 26 | Example | 905 | 504 | 502 | 1452 | 2004 | 98.8 | 824 |
| 27 | Example | 903 | 503 | 501 | 1450 | 2029 | 98.8 | 844 |
| 28 | Example | 903 | 503 | 501 | 1447 | 2065 | 97.4 | 873 |
| 29 | Example | 904 | 504 | 501 | 1446 | 2078 | 98.8 | 883 |
| 31 | Comparative Example | 900 | 505 | 501 | 1462 | 1668 | 98.5 | 665 |
| 32 | Comparative Example | 904 | 504 | 503 | 1461 | 1759 | 98.8 | 702 |
| 33 | Example | 901 | 503 | 503 | 1458 | 1808 | 99.0 | 721 |
| 34 | Example | 904 | 500 | 501 | 1461 | 1798 | 97.4 | 717 |
| 35 | Example | 902 | 504 | 501 | 1460 | 1834 | 98.4 | 731 |
| 36 | Example | 904 | 503 | 502 | 1459 | 1889 | 97.3 | 753 |
| 5 | Example | 903 | 502 | 502 | 1458 | 1943 | 98.4 | 775 |
| 37 | Example | 902 | 500 | 504 | 1457 | 1960 | 98.5 | 782 |
| 38 | Example | 904 | 502 | 502 | 1456 | 1939 | 98.2 | 773 |
| 39 | Comparative Example | 902 | 505 | 503 | 1401 | 1939 | 89.6 | 732 |

TABLE 9

| Sample | Main alloy composition (mass %) | | | | | | | | | |
|---|---|---|---|---|---|---|---|---|---|---|
| No. | Nd | Pr | TRL | B | Al | Ga | Cu | Co | Zr | Fe |
| 41 | 23.69 | 6.12 | 29.81 | 1.16 | 0.13 | 0.08 | 0.19 | 0.51 | 0.38 | Bal. |
| 42 | 23.69 | 6.12 | 29.81 | 1.11 | 0.13 | 0.08 | 0.19 | 0.51 | 0.38 | Bal. |
| 43 | 23.69 | 6.12 | 29.81 | 1.08 | 0.13 | 0.08 | 0.19 | 0.51 | 0.38 | Bal. |
| 5 | 23.69 | 6.12 | 29.81 | 1.06 | 0.13 | 0.08 | 0.19 | 0.51 | 0.38 | Bal. |
| 44 | 23.69 | 6.12 | 29.81 | 1.04 | 0.13 | 0.08 | 0.19 | 0.51 | 0.38 | Bal. |
| 45 | 23.69 | 6.12 | 29.81 | 1.02 | 0.13 | 0.08 | 0.19 | 0.51 | 0.38 | Bal. |
| 46 | 23.69 | 6.12 | 29.81 | 1.00 | 0.13 | 0.08 | 0.19 | 0.51 | 0.38 | Bal. |
| 51 | 23.69 | 6.12 | 29.81 | 1.06 | 0.03 | 0.08 | 0.19 | 0.51 | 0.38 | Bal. |
| 52 | 23.69 | 6.12 | 29.81 | 1.06 | 0.05 | 0.08 | 0.19 | 0.51 | 0.38 | Bal. |
| 5 | 23.69 | 6.12 | 29.81 | 1.06 | 0.13 | 0.08 | 0.19 | 0.51 | 0.38 | Bal. |
| 53 | 23.69 | 6.12 | 29.81 | 1.06 | 0.18 | 0.08 | 0.19 | 0.51 | 0.38 | Bal. |
| 54 | 23.69 | 6.12 | 29.81 | 1.06 | 0.31 | 0.08 | 0.19 | 0.51 | 0.38 | Bal. |
| 55 | 23.69 | 6.12 | 29.81 | 1.06 | 0.42 | 0.08 | 0.19 | 0.51 | 0.38 | Bal. |
| 56 | 23.69 | 6.12 | 29.81 | 1.06 | 0.47 | 0.08 | 0.19 | 0.51 | 0.38 | Bal. |
| 57 | 23.69 | 6.12 | 29.81 | 1.06 | 0.54 | 0.08 | 0.19 | 0.51 | 0.38 | Bal. |
| 58 | 23.69 | 6.12 | 29.81 | 1.06 | 0.58 | 0.08 | 0.19 | 0.51 | 0.38 | Bal. |

TABLE 10

| Sample | Sub alloy composition (mass %) | | | | | | | | | |
|---|---|---|---|---|---|---|---|---|---|---|
| No. | Nd | Pr | TRL | B | Al | Ga | Cu | Co | Zr | Fe |
| 41 | 23.69 | 6.12 | 29.81 | 0.00 | 0.10 | 0.00 | 0.06 | 5.11 | 5.34 | Bal. |
| 42 | 23.69 | 6.12 | 29.81 | 0.00 | 0.10 | 0.00 | 0.06 | 5.11 | 5.34 | Bal. |
| 43 | 23.69 | 6.12 | 29.81 | 0.00 | 0.10 | 0.00 | 0.06 | 5.11 | 5.34 | Bal. |
| 5 | 23.69 | 6.12 | 29.81 | 0.00 | 0.10 | 0.00 | 0.06 | 5.11 | 5.34 | Bal. |
| 44 | 23.69 | 6.12 | 29.81 | 0.00 | 0.10 | 0.00 | 0.06 | 5.11 | 5.34 | Bal. |
| 45 | 23.69 | 6.12 | 29.81 | 0.00 | 0.10 | 0.00 | 0.06 | 5.11 | 5.34 | Bal. |
| 46 | 23.69 | 6.12 | 29.81 | 0.00 | 0.10 | 0.00 | 0.06 | 5.11 | 5.34 | Bal. |
| 51 | 23.69 | 6.12 | 29.81 | 0.00 | 0.10 | 0.00 | 0.06 | 5.11 | 5.34 | Bal. |
| 52 | 23.69 | 6.12 | 29.81 | 0.00 | 0.10 | 0.00 | 0.06 | 5.11 | 5.34 | Bal. |
| 5 | 23.69 | 6.12 | 29.81 | 0.00 | 0.10 | 0.00 | 0.06 | 5.11 | 5.34 | Bal. |
| 53 | 23.69 | 6.12 | 29.81 | 0.00 | 0.10 | 0.00 | 0.06 | 5.11 | 5.34 | Bal. |
| 54 | 23.69 | 6.12 | 29.81 | 0.00 | 0.10 | 0.00 | 0.06 | 5.11 | 5.34 | Bal. |
| 55 | 23.69 | 6.12 | 29.81 | 0.00 | 0.10 | 0.00 | 0.06 | 5.11 | 5.34 | Bal. |
| 56 | 23.69 | 6.12 | 29.81 | 0.00 | 0.10 | 0.00 | 0.06 | 5.11 | 5.34 | Bal. |
| 57 | 23.69 | 6.12 | 29.81 | 0.00 | 0.10 | 0.00 | 0.06 | 5.11 | 5.34 | Bal. |
| 58 | 23.69 | 6.12 | 29.81 | 0.00 | 0.10 | 0.00 | 0.06 | 5.11 | 5.34 | Bal. |

TABLE 11

| | | Mix ratio | Magnet composition (mass %) | | | | | | | | | | | |
|---|---|---|---|---|---|---|---|---|---|---|---|---|---|---|
| Sample | Example/ | (based | | | | Tb | | | | | | | | |
| No. | Comparative Example | on mass) | Nd | Pr | TRL | (TRH) | TRE | B | Al | Ga | Cu | Co | Zr | Fe |
| 41 | Comparative Example | 95:5 | 23.69 | 6.11 | 29.80 | 0.20 | 30.00 | 1.07 | 0.13 | 0.08 | 0.18 | 0.74 | 0.63 | Bal. |
| 42 | Example | 95:5 | 23.69 | 6.11 | 29.80 | 0.20 | 30.00 | 1.05 | 0.13 | 0.08 | 0.18 | 0.74 | 0.63 | Bal. |
| 43 | Example | 95:5 | 23.62 | 6.09 | 29.71 | 0.20 | 29.91 | 1.03 | 0.13 | 0.08 | 0.18 | 0.74 | 0.63 | Bal. |
| 5 | Example | 95:5 | 23.65 | 6.10 | 29.75 | 0.20 | 29.95 | 1.00 | 0.13 | 0.08 | 0.18 | 0.74 | 0.63 | Bal. |
| 44 | Example | 95:5 | 23.67 | 6.11 | 29.78 | 0.20 | 29.98 | 0.99 | 0.13 | 0.08 | 0.18 | 0.74 | 0.63 | Bal. |
| 45 | Example | 95:5 | 23.62 | 6.09 | 29.71 | 0.20 | 29.91 | 0.97 | 0.13 | 0.08 | 0.18 | 0.74 | 0.63 | Bal. |
| 46 | Comparative Example | 95:5 | 23.66 | 6.11 | 29.77 | 0.20 | 29.97 | 0.93 | 0.13 | 0.08 | 0.18 | 0.74 | 0.63 | Bal. |
| 51 | Comparative Example | 95:5 | 23.65 | 6.10 | 29.75 | 0.20 | 29.95 | 1.00 | 0.03 | 0.08 | 0.18 | 0.74 | 0.63 | Bal. |
| 52 | Example | 95:5 | 23.67 | 6.11 | 29.78 | 0.20 | 29.98 | 1.00 | 0.05 | 0.08 | 0.18 | 0.74 | 0.63 | Bal. |
| 5 | Example | 95:5 | 23.65 | 6.10 | 29.75 | 0.20 | 29.95 | 1.00 | 0.13 | 0.08 | 0.18 | 0.74 | 0.63 | Bal. |
| 53 | Example | 95:5 | 23.62 | 6.09 | 29.71 | 0.20 | 29.91 | 1.00 | 0.18 | 0.08 | 0.18 | 0.74 | 0.63 | Bal. |
| 54 | Example | 95:5 | 23.69 | 6.11 | 29.80 | 0.20 | 30.00 | 1.00 | 0.30 | 0.08 | 0.18 | 0.74 | 0.63 | Bal. |
| 55 | Example | 95:5 | 23.66 | 6.11 | 29.77 | 0.20 | 29.97 | 1.00 | 0.40 | 0.08 | 0.18 | 0.74 | 0.63 | Bal. |
| 56 | Example | 95:5 | 23.69 | 6.11 | 29.80 | 0.20 | 30.00 | 1.00 | 0.45 | 0.08 | 0.18 | 0.74 | 0.63 | Bal. |
| 57 | Example | 95:5 | 23.64 | 6.10 | 29.74 | 0.20 | 29.94 | 1.00 | 0.52 | 0.08 | 0.18 | 0.74 | 0.63 | Bal. |
| 58 | Comparative Example | 95:5 | 23.66 | 6.10 | 29.76 | 0.20 | 29.96 | 1.00 | 0.55 | 0.08 | 0.18 | 0.74 | 0.63 | Bal. |

TABLE 12

| | | | | | | | | 160° C. |
|---|---|---|---|---|---|---|---|---|
| Sample | Example/ | CNO content (ppm) | | | Br | HcJ | Hk/HcJ | HcJ |
| No. | Comparative Example | C | N | O | (mT) | (kA/m) | (%) | (kA/m) |
| 41 | Comparative Example | 900 | 502 | 505 | 1458 | 1749 | 89.6 | 740 |
| 42 | Example | 902 | 502 | 503 | 1458 | 1932 | 98.0 | 764 |
| 43 | Example | 904 | 504 | 501 | 1458 | 1938 | 97.5 | 769 |
| 5 | Example | 903 | 502 | 502 | 1458 | 1944 | 98.4 | 775 |
| 44 | Example | 904 | 504 | 500 | 1456 | 1950 | 98.4 | 772 |
| 45 | Example | 901 | 501 | 502 | 1455 | 1955 | 98.8 | 769 |
| 46 | Comparative Example | 904 | 503 | 504 | 1452 | 1652 | 88.6 | 738 |
| 51 | Comparative Example | 901 | 501 | 500 | 1469 | 1747 | 98.8 | 700 |
| 52 | Example | 903 | 500 | 504 | 1467 | 1860 | 98.6 | 745 |
| 5 | Example | 903 | 502 | 502 | 1458 | 1944 | 98.4 | 775 |
| 53 | Example | 902 | 503 | 503 | 1453 | 1950 | 98.7 | 781 |
| 54 | Example | 903 | 502 | 502 | 1439 | 1969 | 98.4 | 799 |
| 55 | Example | 904 | 503 | 502 | 1427 | 1983 | 98.6 | 813 |
| 56 | Example | 900 | 502 | 501 | 1421 | 1991 | 99.0 | 820 |
| 57 | Example | 903 | 503 | 500 | 1416 | 1998 | 97.5 | 827 |
| 58 | Comparative Example | 900 | 505 | 505 | 1410 | 2005 | 97.1 | 834 |

TABLE 13

| Sample | Main alloy composition (mass %) | | | | | | | | | |
|---|---|---|---|---|---|---|---|---|---|---|
| No. | Nd | Pr | TRL | B | Al | Ga | Cu | Co | Zr | Fe |
| 61 | 23.69 | 6.12 | 29.81 | 1.06 | 0.13 | 0.00 | 0.19 | 0.51 | 0.38 | Bal. |
| 62 | 23.69 | 6.12 | 29.81 | 1.06 | 0.13 | 0.03 | 0.19 | 0.51 | 0.38 | Bal. |
| 63 | 23.69 | 6.12 | 29.81 | 1.06 | 0.13 | 0.05 | 0.19 | 0.51 | 0.38 | Bal. |
| 5 | 23.69 | 6.12 | 29.81 | 1.06 | 0.13 | 0.08 | 0.19 | 0.51 | 0.38 | Bal. |
| 64 | 23.69 | 6.12 | 29.81 | 1.06 | 0.13 | 0.15 | 0.19 | 0.51 | 0.38 | Bal. |
| 65 | 23.69 | 6.12 | 29.81 | 1.06 | 0.13 | 0.21 | 0.19 | 0.51 | 0.38 | Bal. |
| 66 | 23.69 | 6.12 | 29.81 | 1.06 | 0.13 | 0.26 | 0.19 | 0.51 | 0.38 | Bal. |
| 71 | 23.69 | 6.12 | 29.81 | 1.06 | 0.13 | 0.08 | 0.19 | 0.00 | 0.38 | Bal. |
| 72 | 23.69 | 6.12 | 29.81 | 1.06 | 0.13 | 0.08 | 0.19 | 0.26 | 0.38 | Bal. |
| 5 | 23.69 | 6.12 | 29.81 | 1.06 | 0.13 | 0.08 | 0.19 | 0.51 | 0.38 | Bal. |
| 73 | 23.69 | 6.12 | 29.81 | 1.06 | 0.13 | 0.08 | 0.19 | 0.79 | 0.38 | Bal. |
| 74 | 23.69 | 6.12 | 29.81 | 1.06 | 0.13 | 0.08 | 0.19 | 1.05 | 0.38 | Bal. |
| 75 | 23.69 | 6.12 | 29.81 | 1.06 | 0.13 | 0.08 | 0.00 | 0.51 | 0.38 | Bal. |
| 76 | 23.69 | 6.12 | 29.81 | 1.06 | 0.13 | 0.08 | 0.05 | 0.51 | 0.38 | Bal. |
| 5 | 23.69 | 6.12 | 29.81 | 1.06 | 0.13 | 0.08 | 0.19 | 0.51 | 0.38 | Bal. |
| 77 | 23.69 | 6.12 | 29.81 | 1.06 | 0.13 | 0.08 | 0.31 | 0.51 | 0.38 | Bal. |
| 78 | 23.69 | 6.12 | 29.81 | 1.06 | 0.13 | 0.08 | 0.37 | 0.51 | 0.38 | Bal. |

TABLE 14

| Sample | Sub alloy composition (mass %) | | | | | | | | | |
|---|---|---|---|---|---|---|---|---|---|---|
| No. | Nd | Pr | TRL | B | Al | Ga | Cu | Co | Zr | Fe |
| 61 | 23.69 | 6.12 | 29.81 | 0.00 | 0.10 | 0.00 | 0.06 | 5.11 | 5.34 | Bal. |
| 62 | 23.69 | 6.12 | 29.81 | 0.00 | 0.10 | 0.00 | 0.06 | 5.11 | 5.34 | Bal. |
| 63 | 23.69 | 6.12 | 29.81 | 0.00 | 0.10 | 0.00 | 0.06 | 5.11 | 5.34 | Bal. |
| 5 | 23.69 | 6.12 | 29.81 | 0.00 | 0.10 | 0.00 | 0.06 | 5.11 | 5.34 | Bal. |
| 64 | 23.69 | 6.12 | 29.81 | 0.00 | 0.10 | 0.00 | 0.06 | 5.11 | 5.34 | Bal. |
| 65 | 23.69 | 6.12 | 29.81 | 0.00 | 0.10 | 0.00 | 0.06 | 5.11 | 5.34 | Bal. |
| 66 | 23.69 | 6.12 | 29.81 | 0.00 | 0.10 | 0.00 | 0.06 | 5.11 | 5.34 | Bal. |
| 71 | 23.69 | 6.12 | 29.81 | 0.00 | 0.10 | 0.00 | 0.06 | 5.11 | 5.34 | Bal. |
| 72 | 23.69 | 6.12 | 29.81 | 0.00 | 0.10 | 0.00 | 0.06 | 5.11 | 5.34 | Bal. |
| 5 | 23.69 | 6.12 | 29.81 | 0.00 | 0.10 | 0.00 | 0.06 | 5.11 | 5.34 | Bal. |
| 73 | 23.69 | 6.12 | 29.81 | 0.00 | 0.10 | 0.00 | 0.06 | 5.11 | 5.34 | Bal. |
| 74 | 23.69 | 6.12 | 29.81 | 0.00 | 0.10 | 0.00 | 0.06 | 5.11 | 5.34 | Bal. |
| 75 | 23.69 | 6.12 | 29.81 | 0.00 | 0.10 | 0.00 | 0.06 | 5.11 | 5.34 | Bal. |
| 76 | 23.69 | 6.12 | 29.81 | 0.00 | 0.10 | 0.00 | 0.06 | 5.11 | 5.34 | Bal. |
| 5 | 23.69 | 6.12 | 29.81 | 0.00 | 0.10 | 0.00 | 0.06 | 5.11 | 5.34 | Bal. |
| 77 | 23.69 | 6.12 | 29.81 | 0.00 | 0.10 | 0.00 | 0.06 | 5.11 | 5.34 | Bal. |
| 78 | 23.69 | 6.12 | 29.81 | 0.00 | 0.10 | 0.00 | 0.06 | 5.11 | 5.34 | Bal. |

TABLE 15

| | | Mix ratio | Magnet composition (mass %) | | | | | | | | | | | |
|---|---|---|---|---|---|---|---|---|---|---|---|---|---|---|
| Sample | Example/ | (based | | | | Tb | | | | | | | | |
| No. | Comparative Example | on mass) | Nd | Pr | TRL | (TRH) | TRE | B | Al | Ga | Cu | Co | Zr | Fe |
| 61 | Example | 95:5 | 23.67 | 6.11 | 29.78 | 0.20 | 29.98 | 1.00 | 0.13 | 0.00 | 0.18 | 0.74 | 0.63 | Bal. |
| 62 | Example | 95:5 | 23.62 | 6.10 | 29.72 | 0.20 | 29.92 | 1.00 | 0.13 | 0.03 | 0.18 | 0.74 | 0.63 | Bal. |
| 63 | Example | 95:5 | 23.66 | 6.10 | 29.76 | 0.20 | 29.96 | 1.00 | 0.13 | 0.05 | 0.18 | 0.74 | 0.63 | Bal. |
| 5 | Example | 95:5 | 23.65 | 6.10 | 29.75 | 0.20 | 29.95 | 1.00 | 0.13 | 0.08 | 0.18 | 0.74 | 0.63 | Bal. |
| 64 | Example | 95:5 | 23.61 | 6.09 | 29.70 | 0.20 | 29.90 | 1.00 | 0.13 | 0.14 | 0.18 | 0.74 | 0.63 | Bal. |
| 65 | Example | 95:5 | 23.62 | 6.09 | 29.71 | 0.20 | 29.91 | 1.00 | 0.13 | 0.20 | 0.18 | 0.74 | 0.63 | Bal. |
| 66 | Comparative Example | 95:5 | 23.69 | 6.11 | 29.80 | 0.20 | 30.00 | 1.00 | 0.13 | 0.25 | 0.18 | 0.74 | 0.63 | Bal. |
| 71 | Example | 95:5 | 23.67 | 6.11 | 29.78 | 0.20 | 29.98 | 1.00 | 0.13 | 0.08 | 0.18 | 0.25 | 0.63 | Bal. |
| 72 | Example | 95:5 | 23.65 | 6.10 | 29.75 | 0.20 | 29.95 | 1.00 | 0.13 | 0.08 | 0.18 | 0.50 | 0.63 | Bal. |
| 5 | Example | 95:5 | 23.65 | 6.10 | 29.75 | 0.20 | 29.95 | 1.00 | 0.13 | 0.08 | 0.18 | 0.74 | 0.63 | Bal. |
| 73 | Example | 95:5 | 23.66 | 6.11 | 29.77 | 0.20 | 29.97 | 1.00 | 0.13 | 0.08 | 0.18 | 1.00 | 0.63 | Bal. |
| 74 | Example | 95:5 | 23.63 | 6.10 | 29.73 | 0.20 | 29.93 | 1.00 | 0.13 | 0.08 | 0.18 | 1.25 | 0.63 | Bal. |
| 75 | Example | 95:5 | 23.69 | 6.11 | 29.80 | 0.20 | 30.00 | 1.00 | 0.13 | 0.08 | 0.00 | 0.74 | 0.63 | Bal. |
| 76 | Example | 95:5 | 23.62 | 6.10 | 29.72 | 0.20 | 29.92 | 1.00 | 0.13 | 0.08 | 0.05 | 0.74 | 0.63 | Bal. |
| 5 | Example | 95:5 | 23.65 | 6.10 | 29.75 | 0.20 | 29.95 | 1.00 | 0.13 | 0.08 | 0.18 | 0.74 | 0.63 | Bal. |
| 77 | Example | 95:5 | 23.62 | 6.10 | 29.72 | 0.20 | 29.92 | 1.00 | 0.13 | 0.08 | 0.30 | 0.74 | 0.63 | Bal. |
| 78 | Example | 95:5 | 23.66 | 6.11 | 29.77 | 0.20 | 29.97 | 1.00 | 0.13 | 0.08 | 0.35 | 0.74 | 0.63 | Bal. |

TABLE 16

| | | | | | | | | 160° C. |
|---|---|---|---|---|---|---|---|---|
| Sample | Example/ | CNO content (ppm) | | | Br | HcJ | Hk/HcJ | HcJ |
| No. | Comparative Example | C | N | O | (mT) | (kA/m) | (%) | (kA/m) |
| 61 | Example | 901 | 502 | 502 | 1464 | 1927 | 98.7 | 725 |
| 62 | Example | 904 | 505 | 505 | 1463 | 1928 | 98.8 | 769 |
| 63 | Example | 904 | 501 | 505 | 1461 | 1935 | 98.0 | 772 |
| 5 | Example | 901 | 505 | 502 | 1458 | 1943 | 97.1 | 775 |
| 64 | Example | 902 | 504 | 503 | 1452 | 1951 | 96.7 | 778 |
| 65 | Example | 900 | 503 | 504 | 1446 | 1958 | 95.1 | 781 |
| 66 | Comparative Example | 902 | 503 | 505 | 1409 | 1974 | 90.3 | 788 |
| 71 | Example | 904 | 501 | 504 | 1449 | 1928 | 98.2 | 769 |
| 72 | Example | 904 | 502 | 500 | 1456 | 1929 | 98.1 | 769 |
| 5 | Example | 904 | 504 | 504 | 1458 | 1943 | 97.6 | 775 |
| 73 | Example | 901 | 504 | 501 | 1457 | 1926 | 99.5 | 768 |
| 74 | Example | 904 | 502 | 500 | 1457 | 1901 | 98.7 | 757 |
| 75 | Example | 903 | 503 | 501 | 1467 | 1819 | 99.1 | 725 |
| 76 | Example | 903 | 502 | 504 | 1465 | 1941 | 98.8 | 774 |
| 5 | Example | 904 | 502 | 503 | 1458 | 1943 | 97.1 | 775 |
| 77 | Example | 901 | 503 | 500 | 1448 | 1930 | 96.5 | 770 |
| 78 | Example | 901 | 502 | 504 | 1446 | 1856 | 95.0 | 740 |

TABLE 17

| Sample | Main alloy composition (mass %) | | | | | | | | | |
|---|---|---|---|---|---|---|---|---|---|---|
| No. | Nd | Pr | TRL | B | Al | Ga | Cu | Co | Zr | Fe |
| 80 | 23.69 | 6.11 | 29.80 | 1.00 | 0.13 | 0.08 | 0.18 | 0.74 | 0.63 | Bal. |
| 81 | 23.69 | 6.12 | 29.81 | 1.00 | 0.13 | 0.08 | 0.19 | 0.51 | 0.38 | Bal. |
| 82 | 23.69 | 6.12 | 29.81 | 1.00 | 0.13 | 0.08 | 0.19 | 0.51 | 0.38 | Bal. |
| 83 | 23.69 | 6.12 | 29.81 | 1.03 | 0.13 | 0.08 | 0.19 | 0.51 | 0.38 | Bal. |
| 84 | 23.69 | 6.12 | 29.81 | 1.08 | 0.13 | 0.08 | 0.19 | 0.51 | 0.38 | Bal. |
| 85 | 23.69 | 6.12 | 29.81 | 1.02 | 0.13 | 0.08 | 0.19 | 0.51 | 0.38 | Bal. |
| 5 | 23.69 | 6.12 | 29.81 | 1.06 | 0.13 | 0.08 | 0.19 | 0.51 | 0.38 | Bal. |
| 86 | 23.69 | 6.12 | 29.81 | 1.11 | 0.13 | 0.08 | 0.19 | 0.51 | 0.38 | Bal. |
| 87 | 23.69 | 6.12 | 29.81 | 1.11 | 0.13 | 0.08 | 0.19 | 0.51 | 0.38 | Bal. |
| 88 | 23.69 | 6.12 | 29.81 | 1.11 | 0.13 | 0.08 | 0.19 | 0.51 | 0.38 | Bal. |

TABLE 18

| Sample | Sub alloy composition (mass %) | | | | | | | | | |
|---|---|---|---|---|---|---|---|---|---|---|
| No. | Nd | Pr | TRL | B | Al | Ga | Cu | Co | Zr | Fe |
| 80 | N/A | | | | | | | | | |
| 81 | 23.69 | 6.12 | 29.81 | 0.00 | 0.10 | 0.00 | 0.06 | 5.11 | 7.01 | Bal. |
| 82 | 23.69 | 6.12 | 29.81 | 0.00 | 0.10 | 0.00 | 0.06 | 5.11 | 5.34 | Bal. |
| 83 | 23.69 | 6.12 | 29.81 | 0.00 | 0.10 | 0.00 | 0.06 | 5.11 | 5.34 | Bal. |
| 84 | 23.69 | 6.12 | 29.81 | 0.00 | 0.10 | 0.00 | 0.06 | 5.11 | 5.34 | Bal. |
| 85 | 23.69 | 6.12 | 29.81 | 0.00 | 0.10 | 0.00 | 0.06 | 5.11 | 5.34 | Bal. |
| 5 | 23.69 | 6.12 | 29.81 | 0.00 | 0.10 | 0.00 | 0.06 | 5.11 | 5.34 | Bal. |
| 86 | 23.69 | 6.12 | 29.81 | 0.00 | 0.10 | 0.00 | 0.06 | 5.11 | 5.34 | Bal. |
| 87 | 23.69 | 6.12 | 29.81 | 0.00 | 0.10 | 0.00 | 0.06 | 5.11 | 2.86 | Bal. |
| 88 | 23.69 | 6.12 | 29.81 | 0.00 | 0.10 | 0.00 | 0.06 | 4.26 | 2.86 | Bal. |

TABLE 19

| | | Mix ratio | Magnet composition (mass %) | | | | | | | | | | | |
|---|---|---|---|---|---|---|---|---|---|---|---|---|---|---|
| Sample | Example/ | (based | | | | Tb | | | | | | | | |
| No. | Comparative Example | on mass) | Nd | Pr | TRL | (TRH) | TRE | B | Al | Ga | Cu | Co | Zr | Fe |
| 80 | Comparative Example | 100:0 | 23.64 | 6.10 | 29.74 | 0.20 | 29.94 | 1.00 | 0.13 | 0.08 | 0.18 | 0.74 | 0.63 | Bal. |
| 81 | Comparative Example | 98:2 | 23.67 | 6.11 | 29.78 | 0.20 | 29.98 | 0.98 | 0.13 | 0.08 | 0.18 | 0.60 | 0.52 | Bal. |
| 82 | Example | 97:3 | 23.68 | 6.11 | 29.79 | 0.20 | 29.99 | 0.97 | 0.13 | 0.08 | 0.18 | 0.65 | 0.53 | Bal. |
| 83 | Example | 97:3 | 23.66 | 6.10 | 29.76 | 0.20 | 29.96 | 1.00 | 0.13 | 0.08 | 0.18 | 0.65 | 0.53 | Bal. |
| 84 | Example | 97:3 | 23.64 | 6.10 | 29.74 | 0.20 | 29.94 | 1.05 | 0.13 | 0.08 | 0.18 | 0.65 | 0.53 | Bal. |
| 85 | Example | 95:5 | 23.65 | 6.10 | 29.80 | 0.20 | 30.00 | 0.97 | 0.13 | 0.08 | 0.18 | 0.74 | 0.63 | Bal. |
| 5 | Example | 95:5 | 23.65 | 6.10 | 29.75 | 0.20 | 29.95 | 1.00 | 0.13 | 0.08 | 0.18 | 0.74 | 0.63 | Bal. |
| 86 | Example | 95:5 | 23.65 | 6.10 | 29.71 | 0.20 | 29.91 | 1.05 | 0.13 | 0.08 | 0.18 | 0.74 | 0.63 | Bal. |
| 87 | Example | 90:10 | 23.68 | 6.11 | 29.79 | 0.20 | 29.99 | 1.00 | 0.13 | 0.08 | 0.17 | 0.97 | 0.63 | Bal. |
| 88 | Example | 88:12 | 23.67 | 6.11 | 29.78 | 0.20 | 29.98 | 0.98 | 0.13 | 0.07 | 0.17 | 0.96 | 0.68 | Bal. |

TABLE 20

| | | | | | | | | 160° C. |
|---|---|---|---|---|---|---|---|---|
| Sample | Example/ | CNO content (ppm) | | | Br | HcJ | Hk/HcJ | HcJ |
| No. | Comparative Example | C | N | O | (mT) | (kA/m) | (%) | (kA/m) |
| 80 | Comparative Example | 896 | 500 | 503 | 1458 | 1825 | 92.2 | 701 |
| 81 | Comparative Example | 903 | 496 | 503 | 1461 | 1838 | 95.6 | 706 |
| 82 | Example | 904 | 503 | 502 | 1460 | 1955 | 98.3 | 780 |
| 83 | Example | 901 | 503 | 499 | 1460 | 1944 | 99.3 | 775 |
| 84 | Example | 899 | 497 | 496 | 1460 | 1932 | 97.7 | 770 |
| 85 | Example | 905 | 504 | 503 | 1458 | 1955 | 97.4 | 780 |
| 5 | Example | 903 | 502 | 502 | 1458 | 1943 | 97.4 | 775 |
| 86 | Example | 896 | 505 | 505 | 1458 | 1932 | 97.6 | 770 |
| 87 | Example | 904 | 504 | 505 | 1458 | 1945 | 98.5 | 776 |
| 88 | Example | 903 | 497 | 500 | 1457 | 1953 | 98.7 | 779 |

With regard to Sample Nos. 31 to 39, in which mainly the Zr content was changed from that of Sample No. 5, Sample Nos. 41 to 46, in which mainly the B content was changed from that of Sample No. 5, and Sample Nos. 80, 81, 83, 87, and 88, in which mainly the mix ratio of the main alloy to the sub alloy was changed from that of Sample No. 5, the area ratio of Zr—C phases was measured. Also with regard to Sample No. 5, the area ratio of the Zr—C phases was measured.

Zr elemental mapping and C elemental mapping of a cross-section of each sample were performed using an EPMA (JXA-8500F manufactured by JEOL Ltd.) at an accelerating voltage of 15 kV, an illumination current of 200 nA, at an analysis step of 0.20 nm/step, for a field of view measuring 51.2 μm×51.2 μm. A Zr elemental mapping image and a C elemental mapping image were stacked to identify locations of the Zr—C phases. The area of the Zr—C phases was divided by the area of the mapping images, i.e., 51.2 μm×51.2 μm, to calculate the area ratio of the Zr—C phases. Table 21 shows the results.

It was confirmed that the area ratio of the Zr—C phases of Examples not shown in Table 21 was 0.50% or more and 2.60% or less.

TABLE 21

| | | | | | Zr—C | | | | |
|---|---|---|---|---|---|---|---|---|---|
| | | Mix ratio | | | area | | | | 160° C. |
| Sample | Example/ | (based | B | Zr | ratio | Br | HcJ | Hk/HcJ | HcJ |
| No. | Comparative Example | on mass) | (mass %) | (mass %) | (%) | (mT) | (kA/m) | (%) | (kA/m) |
| 31 | Comparative Example | 95:5 | 1.00 | 0.45 | 0.45 | 1462 | 1668 | 98.5 | 665 |
| 32 | Comparative Example | 95:5 | 1.00 | 0.49 | 0.49 | 1461 | 1759 | 98.8 | 702 |
| 33 | Example | 95:5 | 0.99 | 0.51 | 0.50 | 1458 | 1808 | 99.0 | 721 |
| 34 | Example | 95:5 | 1.00 | 0.51 | 1.09 | 1461 | 1798 | 97.4 | 717 |
| 35 | Example | 95:5 | 0.97 | 0.53 | 1.13 | 1460 | 1834 | 98.4 | 731 |
| 36 | Example | 95:5 | 1.00 | 0.57 | 1.22 | 1459 | 1889 | 97.3 | 753 |
| 5 | Example | 95:5 | 1.00 | 0.63 | 1.76 | 1458 | 1943 | 98.4 | 775 |
| 37 | Example | 95:5 | 1.00 | 0.69 | 1.93 | 1457 | 1960 | 98.5 | 782 |
| 38 | Example | 95:5 | 1.00 | 0.74 | 2.50 | 1456 | 1939 | 98.2 | 773 |
| 39 | Comparative Example | 95:5 | 1.00 | 0.80 | 2.73 | 1401 | 1939 | 89.6 | 732 |
| 41 | Comparative Example | 95:5 | 1.07 | 0.63 | 0.47 | 1458 | 1749 | 89.6 | 740 |
| 42 | Example | 95:5 | 1.05 | 0.63 | 0.84 | 1458 | 1932 | 98.0 | 764 |
| 43 | Example | 95:5 | 1.03 | 0.63 | 1.21 | 1458 | 1938 | 97.5 | 769 |
| 5 | Example | 95:5 | 1.00 | 0.63 | 1.76 | 1458 | 1944 | 98.4 | 775 |
| 44 | Example | 95:5 | 0.99 | 0.63 | 1.83 | 1456 | 1950 | 98.4 | 772 |
| 45 | Example | 95:5 | 0.97 | 0.63 | 1.96 | 1455 | 1955 | 98.8 | 769 |
| 46 | Comparative Example | 95:5 | 0.93 | 0.63 | 2.52 | 1452 | 1652 | 88.6 | 738 |
| 80 | Comparative Example | 100:0 | 1.00 | 0.63 | 1.16 | 1458 | 1825 | 92.2 | 701 |
| 81 | Comparative Example | 98:2 | 0.98 | 0.52 | 0.49 | 1461 | 1838 | 95.6 | 706 |
| 83 | Example | 97:3 | 1.00 | 0.53 | 1.13 | 1460 | 1944 | 99.3 | 775 |
| 5 | Example | 95:5 | 1.00 | 0.63 | 1.76 | 1458 | 1943 | 97.4 | 775 |
| 87 | Example | 90:10 | 1.00 | 0.63 | 1.67 | 1458 | 1945 | 98.5 | 776 |
| 88 | Example | 88:12 | 0.98 | 0.68 | 2.37 | 1457 | 1953 | 98.7 | 779 |

The R-T-B based permanent magnet of each Example had good Br at room temperature, good HcJ at room temperature, good Hk/HcJ at room temperature, and good HcJ at high temperatures.

In contrast, Sample No. 1, in which TRL was too high, had low Br at room temperature. In Sample No. 10, in which TRL was too low, sintering was not able to proceed sufficiently. Specifically, the density of the sintered body of Sample No. 10 was less than 90% of the density of the sintered body of Sample No. 5.

Sample Nos. 31 and 32, in which the Zr content was too low, had low HcJ at room temperature and low HcJ at high temperatures. Sample No. 39, in which the Zr content was too high, had low Br at room temperature and low Hk/HcJ at room temperature.

Sample Nos. 31 and 32, in which the Zr content was too low, had a low area ratio of the Zr—C phases. Sample No. 39, in which the Zr content was too high, had a high area ratio of the Zr—C phases.

Sample No. 41, in which the B content was too high, had low HcJ at room temperature and low Hk/HcJ at room temperature. Sample No. 46, in which the B content was too low, had low HcJ at room temperature and low Hk/HcJ at room temperature.

Sample No. 41, in which the B content was too high, had a low area ratio of the Zr—C phases. Sample No. 46, in which the B content was too low, had a high area ratio of the Zr—C phases.

Sample No. 51, in which the Al content was too low, had low HcJ at room temperature and low HcJ at high temperatures. Sample No. 58, in which the Al content was too high, had low Br at room temperature.

Sample No. 66, in which the Ga content was too high, had low Br at room temperature and low Hk/HcJ at room temperature.

Sample No. 80, which was prepared with the one-alloy method without use of a sub alloy, had lower HcJ at room temperature and lower Hk/HcJ at room temperature than those of Sample No. 5, which had substantially the same composition. Moreover, Sample No. 80 had lower HcJ at high temperatures.

Sample No. 80, which was prepared with the one-alloy method without use of a sub alloy, had a lower area ratio of the Zr—C phases than that of Sample No. 5, which had substantially the same composition.

In Sample No. 81, in which the mix ratio of the main alloy was too high, the main alloy powder and the sub alloy powder were not appropriately mixed. Thus, Sample No. 81 had lower properties, particularly lower HcJ at high temperatures, than those of other Examples.

Sample No. 81, in which the mix ratio of the main alloy was too high, had a lower area ratio of the Zr—C phases than that of Sample No. 5, which had substantially the same composition.

### REFERENCE NUMERALS

1 . . . R-T-B based permanent magnet
11 . . . main phase grain
13 . . . grain boundary
15 . . . Zr—C phase
17 . . . Zr—B phase

What is claimed is:

1. An R-T-B based permanent magnet comprising:
28.0 mass % or more and 31.5 mass % or less light rare earth element in total;
more than 0 mass % and 1.0 mass % or less heavy rare earth element in total;
0.97 mass % or more and 1.05 mass % or less B;
0.05 mass % or more and 0.52 mass % or less Al;
0.50 mass % or more and 0.75 mass % or less Zr;
0 mass % or more and 0.20 mass % or less Ga; and
0 mass ppm or more and 1000 mass ppm or less O,
wherein the R-T-B based permanent magnet has a coercivity of 715 kA/m or more at 160° C.

2. The R-T-B based permanent magnet according to claim 1, comprising 0.53 mass % or more and 0.75 mass % or less Zr.

3. The R-T-B based permanent magnet according to claim 1, comprising more than 0 mass % and 0.20 mass % or less heavy rare earth element in total.

4. The R-T-B based permanent magnet according to claim 1, comprising 0.50 mass % or more and 0.80 mass % or less Co.

5. The R-T-B based permanent magnet according to claim 1, having a concentration gradient of the heavy rare earth element decreasing inward from a surface of the R-T-B based permanent magnet.

6. The R-T-B based permanent magnet according to claim 1, wherein
the R-T-B based permanent magnet comprises
main phase grains, and
a grain boundary between two or more of the main phase grains adjacent to each other,
the grain boundary comprises a Zr—C phase, and
the Zr—C phase occupies an area ratio of 0.50% or more and 2.60% or less of a cross-section of the R-T-B based permanent magnet.

7. A method of manufacturing an R-T-B based permanent magnet, comprising:
preparing a main alloy and a sub alloy; and
mixing the main alloy and the sub alloy,
wherein
the main alloy comprises 1.03 mass % or more and 1.11 mass % or less B, and
the sub alloy comprises 0.96 mass % or more and 15.0 mass % or less Zr.
